(19) United States
(12) Patent Application Publication
(10) Pub. No.: US 2026/0223108 A1
(43) Pub. Date: Jul. 30, 2026

(54) CODEBOOK DESIGN FOR 8TX UE WITH FOUR COHERENT ANTENNA GROUPS

(71) Applicant: Lenovo (Beijing) Limited, Beijing (CN)

(72) Inventors: Chenxi Zhu, Fairfax, VA (US); Bingchao Liu, Beijing (CN); Yi Zhang, Beijing (CN); Wei Ling, Beijing (CN); Lingling Xiao, Beijing (CN)

(73) Assignee: Lenovo (Beijing) Limited, Beijing (CN)

(21) Appl. No.: 19/144,625

(22) PCT Filed: Apr. 6, 2023
(86) PCT No.: PCT/CN2023/086637

§ 371 Date: Jun. 30, 2025

(51) Int. Cl. H04W 72/1268; H04B 7/0456

(52) U.S. Cl. CPC H04W 72/1268; H04B 7/0456

(57) ABSTRACT

Methods and apparatuses for 8TX UE with four coherent antenna groups are disclosed. In one embodiment, a UE comprises a transceiver; and a processor coupled to the transceiver, wherein the processor is configured to receive, via the transceiver, a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and transmit, via the transceiver, the scheduled PUSCH transmission according to the control message.

### FIELD

The subject matter disclosed herein generally relates to wireless communications, and more particularly relates to methods and apparatuses for codebooks for 8TX UE (UE with 8 antenna ports) with four coherent antenna groups.

### BACKGROUND

Physical Uplink Shared Channel (PUSCH) transmission with 8 antenna ports (8TX PUSCH) is supported in New Radio (NR) Release 18 for advanced UE equipped with 8 antennas with one or multiple layers.

This disclosure targets codebooks for 8TX User Equipment (UE) with four coherent antenna groups.

### BRIEF SUMMARY

Methods and apparatuses for 8TX UE with four coherent antenna groups are disclosed.

In one embodiment, a UE comprises a transceiver; and a processor coupled to the transceiver, wherein the processor is configured to receive, via the transceiver, a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and transmit, via the transceiver, the scheduled PUSCH transmission according to the control message.

In some embodiment, the four coherent antenna groups are divided into two antenna group pairs each of which consists of two coherent antenna groups, and the TMPI indicates one or two 4TX partial coherent precoding matrices each of which is used by one of the two antenna group pairs.

In some embodiment, each 4TX partial coherent precoding matrix is split into two 2TX precoding matrices, each of which is used as the precoding matrix of one of the two coherent antenna groups of the antenna group pair using the 4TX partial coherent precoding matrix. If the transmission rank is 1, the one 4TX partial coherent precoding matrix is 4TX rank 1 precoding matrix and is used by one antenna group pair indicated by the TPMI. If the transmission rank is 2, both 4TX partial coherent precoding matrices are 4TX rank 1 precoding matrices. If the transmission rank is 3, one of the two 4TX partial coherent precoding matrices is 4TX rank 1 precoding matrix and the other of the two 4TX partial coherent precoding matrices is 4TX rank 2 precoding matrix. If the transmission rank is 4, both 4TX partial coherent precoding matrices are 4TX rank 2 precoding matrices. If the transmission rank is 5, one of the two 4TX partial coherent precoding matrices is 4TX rank 2 precoding matrix and the other of the two 4TX partial coherent precoding matrices is 4TX rank 3 precoding matrix. If the transmission rank is 6, both 4TX partial coherent precoding matrices are 4TX rank 3 precoding matrices. If the transmission rank is 7, one of the two 4TX partial coherent precoding matrices is 4TX rank 3 precoding matrix and the other of the two 4TX partial coherent precoding matrices is 4TX rank 4 precoding matrix. If the transmission rank is 8, and both 4TX partial coherent precoding matrices are 4TX rank 4 precoding matrices.

In some embodiment, each 4TX partial coherent precoding matrix is chosen from all 4TX partial coherent precoding matrices of a proper rank.

In some embodiment, at least one of the two partial coherent precoding matrices is chosen from only a part of 4TX partial coherent precoding matrices of a proper rank. In particular, the 2TX precoding matrix of each coherent antenna group is different from the 2TX precoding matrix of any other coherent antenna group.

In some embodiment, the TPMI includes a single indication of the one 4TX partial coherent precoding matrix or a combination of the two 4TX partial coherent precoding matrices.

Alternatively, the TPMI includes a first part indicating one of the two 4TX partial coherent precoding matrix and a second part indicating the other of the two 4TX partial coherent precoding matrix. In particular, the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

In some embodiment, each of the split two 2TX precoding matrices is applied to one coherent antenna group including two antenna ports depending on antenna ports numbering.

In some embodiment, the TPMI indicates a combination of coherent antenna groups and 2TX rank 1 full coherent precoding matrices. If the transmission rank is 1, the TMPI indicates one of the four coherent antenna groups and one 2TX rank 1 full coherent precoding matrix. If the transmission rank is 2, the TMPI indicates a combination of two of the four coherent antenna groups and a combination of two 2TX rank 1 full coherent precoding matrices.

If the transmission rank is 3, the TMPI indicates a combination of three of the four coherent antenna groups and a combination of three 2TX rank 1 full coherent precoding matrices. If the transmission rank is 4, the 8TX rank 4 precoding matrix is consisted of four 2TX rank 1 full coherent precoding matrices, wherein, the four 2TX rank 1 full coherent precoding matrices are applied to the four coherent antenna groups in a sequential manner. If the transmission rank is 5, the TPMI indicates one of a third coherent antenna group and a fourth coherent antenna group to which one 2TX rank 1 full coherent precoding matrix is added and which one of the four 2TX rank 1 full coherent precoding matrices is the added one 2TX rank 1 full coherent precoding matrix. If the transmission rank is 6, the TPMI indicates one of a first coherent antenna group and a second coherent antenna group to which a first 2TX rank 1 full coherent precoding matrix is added and one of a third coherent antenna group and a fourth coherent antenna group to which a second 2TX rank 1 full coherent precoding matrix is added, and which one of the four 2TX rank 1 full coherent precoding matrices is the added first 2TX rank 1 full coherent precoding matrix and which one of the four 2TX rank 1 full coherent precoding matrices is the added second 2TX rank 1 full coherent precoding matrix. If the transmission rank is 7, the TPMI indicates one of a first coherent antenna group and a second coherent antenna group to which a first 2TX rank 1 full coherent precoding matrix is added, and which one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and which one of the four 2TX rank 1 full coherent precoding matrices is an added third 2TX rank 1 full coherent precoding matrix to a fourth coherent antenna group. If the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group. In particular, each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and if there are two or three or four added 2TX rank 1 full coherent precoding matrices, each of the two or three or four added 2TX rank 1 full coherent precoding matrices is different.

In some embodiment, if the transmission rank is r that is larger than 4, the TPMI indicates r-4 2TX rank 1 full coherent precoding matrix(ces), each of which is added to one of r-4 antenna groups based on 8TX rank 4 precoding matrix. If r is 5, one 2TX rank 1 full coherent precoding matrix is added to a third antenna group or a fourth antenna group. If r is 7, one 2TX rank 1 full coherent precoding matrix is added to a first antenna group or a second antenna group, and two 2TX rank 1 full coherent precoding matrices are added to the third antenna group and the fourth antenna group. Each of the antenna group(s) to which one 2TX rank 1 full coherent precoding matrix is added transmits two data layers.

In another embodiment, a method performed at a UE comprises receiving a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and transmitting the scheduled PUSCH transmission according to the control message.

In still another embodiment, a base unit comprises a transceiver; and a processor coupled to the transceiver, wherein the processor is configured to transmit, via the transceiver, a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and receive, via the transceiver, the scheduled PUSCH transmission transmitted according to the control message.

In yet another embodiment, a method performed at a base unit comprises transmitting a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and receiving the scheduled PUSCH transmission transmitted according to the control message.

### BRIEF DESCRIPTION OF THE DRAWINGS

A more particular description of the embodiments briefly described above will be rendered by reference to specific embodiments that are illustrated in the appended drawings.

Understanding that these drawings depict only some embodiments, and are not therefore to be considered to be limiting of scope, the embodiments will be described and explained with additional specificity and detail through the use of the accompanying drawings, in which:

FIG. 1 illustrates several antenna layouts with different number of antenna groups;

FIGS. 2(a) and 2(b) illustrate a first antenna ports numbering;

FIGS. 3(a) and 3(b) illustrate a second antenna ports numbering;

FIGS. 4(a) and 4(b) illustrate a third antenna ports numbering;

FIGS. 5(a) and 5(b) illustrate a fourth antenna ports numbering;

FIG. 6 is a schematic flow chart diagram illustrating an embodiment of a method;

FIG. 7 is a schematic flow chart diagram illustrating an embodiment of another method; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”.

The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The UE can be configured in two different modes for PUSCH multi-antenna precoding, referred as codebook (CB) based transmission and non-codebook (nCB) based transmission, respectively. When the UE is configured with codebook based PUSCH transmission, one Sounding Reference Signal (SRS) resource set used for codebook can be configured in a Bandwidth Part (BWP) of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the Next Generation Node B (gNB) determines a suitable transmission rank (which may be abbreviated as “rank” hereinafter) and the precoding matrix from a pre-defined codebook, which includes a set of precoding matrices with different ranks, and sends the information to the UE when scheduling a PUSCH transmission.

When a UE is equipped with 8 antenna ports (e.g., PUSCH or SRS antenna ports), the base unit (e.g., gNB) may send to the UE a Downlink Control Information (DCI) (e.g., DCI with format 0_1 or DCI with format 0_2) scheduling dynamically scheduled PUSCH or type 2 configured-grant PUSCH with up to 8 layers (i.e., PUSCH layers) or a Radio Resource Control (RRC) message (e.g., configuredGrantConfig) to configure type 1 configured-grant PUSCH with up to 8 layers. The 8 antenna ports (e.g., PUSCH or SRS antenna ports) may be numbered as PUSCH or SRS antenna ports 1000, 1001, 1002, 1003, 1004, 1005, 1006, and 1007. Incidentally, a brief summary of configured grant (CG) PUSCH is as follows. CG PUSCH is used for semi-static Uplink (UL) traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig 1E) and each configuredGrantConfig has an ID.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0} - 1 )} ( i )\end{matrix} ] \qquad Equation 1$$

where, the block of vector

$${[ {y}_{0}^{( 0 )} ( i ) … {y}_{0}^{( {v}_{0} - 1 )} ( i ) ]}^{T}$$

is the modulated data that will be transmitted; W₀ is the precoding matrix applied to the block of vector; and the block of vector

$${[ {z}_{0}^{( {P}_{0} )} ( i ) … {z}_{0}^{( {P}_{ρ - 1} )} ( i ) ]}^{T}$$

is the pre-coded data to be transmitted by the UE. v₀ indicates the number of PUSCH layers or the rank of the PUSCH. P₀ corresponds to PUSCH antenna port 1000 and P_{ρ-1} corresponds to PUSCH antenna port 1000+ρ−1. In this invention, ρ=8.

Coherent transmission is described as follows:

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

is a valid precoding vector for a rank 1 PUSCH transmission with 8 full coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

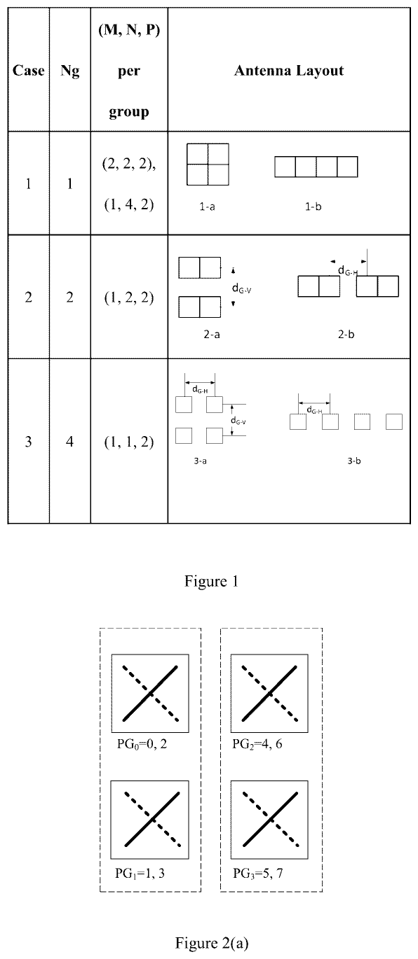

If a UE reports capability of partial-coherent or non-coherent with 8 antenna ports (i.e., PUSCH antenna port 1000, 1001, 1002, 1003, 1004, 1005, 1006 and 1007), only coherent antenna ports (where the coherent antenna ports are a part of the 8 antenna ports) can be used for transmission of one PUSCH layer. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 1.

In FIG. 1, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna port.

Antenna layout 1-a and antenna layout 1-b correspond to full coherent antenna array, i.e., all 8 antenna ports within each of antenna layout 1-a and antenna layout 1-b belong to one antenna group (e.g., antenna group #0, denoted as nNg=0) and are coherent antenna ports.

Antenna layout 2-a and antenna layout 2-b correspond to partial coherent antenna array with two antenna groups (Ng=2). For example, in each of antenna layout 2-a and antenna layout 2-b, each of antenna group #0 (a first antenna group, denoted as nNg=0) and antenna group #1 (a second antenna group, denoted as nNg=1) includes four coherent antenna ports.

Antenna layout 3-a and antenna layout 3-b correspond to partial coherent antenna array with four antenna groups (Ng=4). For example, in each of antenna layout 3-a and antenna layout 3-b, each of antenna group #0 (a first antenna group, denoted as nNg=0), antenna group #1 (a second antenna group, denoted as nNg=1), antenna group #2 (a third antenna group, denoted as nNg=2), and antenna group #3 (a fourth antenna group, denoted as nNg=3) includes two coherent antenna ports.

Before discussing the codebook design, the UE needs to report its antenna layout including the number of antenna groups 1≤Ng≤4, and optionally the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

The UE can report the supported maxRank ∈{1, 2, 3, 4, 5, 6, 7, 8}, i.e., the maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than maxRank. A precoding matrix (which can also be referred to as precoder) shall be determined for the scheduled PUSCH transmission.

Incidentally, the number of columns of the precoding matrix indicates the number of layers of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder. The number of rows of the precoding matrix (precoder) indicates the number of antenna ports for which the precoding matrix can be applied. For example, the precoding matrix (precoder) may have 2 or 4 or 8 rows (denoted as 2TX, 4TX, 8TX) for a UE with 2 antenna ports or 4 antenna ports or 8 antenna ports.

This disclosure targets codebooks for 8TX UE (i.e., UE with 8 antenna ports) with four coherent antenna groups (i.e., Ng=4). When Ng=4, 8 antenna ports are arranged in four antenna groups, that are coherent and each has 2 antenna ports. Each box represents a pair of coherent cross-polarized antennas. In the following description, “coherent antenna group” is abbreviated as “antenna group”, and can be also referred to as “antenna port group” or “port group”.

Before describing the embodiments, antenna ports numbering and antenna groups layout are described.

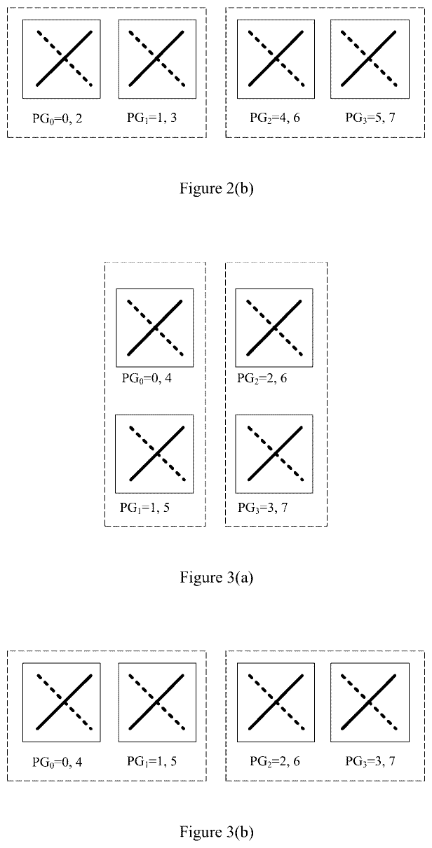

The 8TX UE has eight antenna ports in four antenna groups. The eight antenna ports are numbered as 0 to 7. The four antenna groups (or port groups) can be denoted as PG₀, PG₁, PG₂, and PG₃. Each antenna group includes two antennas that are in 2 different polarization directions, where each antenna corresponds to one antenna port. As shown in FIG. 2(a) or 2(b), each slash represents one antenna, the four slashes in solid line are of a first polarization direction, and the four slashes in dotted line are of a second polarization direction.

Antenna ports numbering is related to how to number the two antenna ports in each antenna group. FIG. 2(a) illustrates an example of antenna ports numbering (e.g., a first antenna ports numbering). As shown in FIG. 2(a), PG₀ includes antenna ports 0 and 2, PG₁ includes antenna ports 1 and 3, PG₂ includes antenna ports 4 and 6, and PG₃ includes antenna ports 5 and 7.

Antenna groups layout is related to the arrangement of the four antenna groups.

FIG. 2(a) illustrates antenna layout 3-a (i.e., 2×2) shown in FIG. 1. That is, the four antenna groups are arranged into two columns where each column has 2 rows. FIG. 2(b) illustrates antenna layout 3-a (i.e., 1×4) shown in FIG. 1 with the same antenna ports numbering as FIG. 2(a). That is, the four antenna groups are arranged into four columns where each column has 1 row.

The transmission from the UE with 4 coherent antenna groups to the TRP can be represented as:

$$Y = HWX + N = [ {H}_{0} {H}_{1} {H}_{2} {H}_{3} ] [ \begin{matrix}{W}_{0} & 0 & 0 & 0 \\ 0 & {W}_{1} & 0 & 0 \\ 0 & 0 & {W}_{2} & 0 \\ 0 & 0 & 0 & {W}_{3}\end{matrix} ] [ \begin{matrix}{X}_{0} \\ {X}_{1} \\ {X}_{2} \\ {X}_{3}\end{matrix} ] + N ,$$

where, Hᵢ, Wᵢ, Xᵢ are the channel, precoding matrix, and information from the antenna group i (i is any one from 0 to 3) to the TRP respectively, and N is the receiver noise vector.

According to a first embodiment, the precoding matrices in NR Release 15 2TX rank 1 codebook can be used to construct each of W₀, W₁, W₂ and W₃.

2TX rank 1 codebook is given by Table 6.3.1.5-1 specified in 3GPP Technical Specification TS38.211 V16.0.0 as follows:

TABLE 6.3.1.5-1
Precoding matrix W for single-layer transmission using two
antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

The 2TX rank 1 precoding matrices (with Transmit Precoding Matrix Indicator (TPMI) index from 0 to 5) can be classified into two groups:

A first group with Type #1 denoted as

$$2 {G}_{1}^{1}$$

includes precoding matrices with indices of 0 to 1 (i.e., {TPMI indices 0-1}), in which one port is selected out of 2 ports for transmission (i.e., each of precoding matrices with indices of 0 to 1 has only one non-zero value).

A second group with Type #2 denoted as

$$2 {G}_{2}^{1}$$

includes precoding matrices with indices of 2 to 5 (i.e., {TPMI indices 2-5}), which all two ports are used for transmission. The precoding matrices with indices of 2 to 5 in 2TX rank 1 codebook given by Table 6.3.1.5-1 can be referred to as 2TX rank 1 full coherent precoding matrices.

The first embodiment proposes that 2TX rank 1 full coherent precoding matrices

$$( i . e . , 2 {G}_{2}^{1} )$$

can be used construct each of W₀, W₁, W₂ and W₃. The 8TX rank N (N is from 1 to 8) precoding matrix W^{N} takes the form

$$a [ \begin{matrix}{W}_{0} & 0 & 0 & 0 \\ 0 & {W}_{1} & 0 & 0 \\ 0 & 0 & {W}_{2} & 0 \\ 0 & 0 & 0 & {W}_{3}\end{matrix} ] ,$$

where a is a normalization factor, e.g.,

$$\frac{1}{2 \sqrt{2}}$$

for 8TX precoding matrix. For ease of discussion, all four 2TX rank 1 full coherent precoding matrices

$$( i . e . , 2 {G}_{2}^{1} )$$

are listed as follows:

$$\frac{1}{\sqrt{2}} [ \begin{matrix}1 \\ 1\end{matrix} ] , \frac{1}{\sqrt{2}} [ \begin{matrix}1 \\ - 1\end{matrix} ] , \frac{1}{\sqrt{2}} [ \begin{matrix}1 \\ j\end{matrix} ] , \frac{1}{\sqrt{2}} [ \begin{matrix}1 \\ - j\end{matrix} ] ,$$

where index 0, 1, 2, 3 (instead of 2 to 5) can be used to indicate each of the four 2TX rank 1 full coherent precoding matrices.

The first embodiment will be described by taking the first antenna ports numbering shown in FIG. 2(a) or 2(b) as the antenna ports numbering. That is, PG₀ includes antenna ports 0 and 2, in which W₀ is the precoding matrix for PG₀ (i.e., for antenna ports 0 and 2); PG₁ includes antenna ports 1 and 3, in which W₁ is the precoding matrix for PG₁(i.e., for antenna ports 1 and 3); PG₂ includes antenna ports 4 and 6, in which W₂ is the precoding matrix for PG₂ (i.e., for antenna ports 4 and 6), PG₃ includes antenna ports 5 and 7, in which W₃ is the precoding matrix for PG₃ (i.e., for antenna ports 5 and 7).

Depending on the rank 1~8, a subset or all of four antenna groups are used for transmission (the details will be described later). The number of data layers transmitted by each antenna group PGᵢ (i is from 0 to 3) can be 0, 1 or 2 (the details will also be described later). In the following description, “data layer” is abbreviated as “layer”). So, each of W₀~W₃ will be indicated for rank N (where N is from 1 to 8) transmission (i.e., N layers are transmitted). The rank of 2TX precoding matrix (i.e., each of W₀~W₃) for each of the antenna group(s) used for transmission is 1 or 2.

A first sub-embodiment of the first embodiment relates to 8TX rank 1 codebook for 8TX UE with four coherent antenna groups, which includes 8TX rank 1 precoding matrices (W¹), each of which is constructed using one 2TX rank 1 full coherent precoding matrix.

For rank 1 with one layer, the one layer is transmitted by only one of the four antenna groups (i.e., only one of W₀~W₃ is non-zero), while the other three antenna groups are not used for transmission (i.e., the other three of W₀~W₃ is zero). Any one of the four antenna groups (PG₀, PG₁, PG₂, PG₃) should be able to transmit the one layer. So, 2 bits are necessary to indicate one of the four antenna groups for transmission. In addition, one rank 1 precoding matrix from

$$2 {G}_{2}^{1}$$

can be indicated by 2 bits as the precoding matrix of the indicated one antenna group. Accordingly, a total of 4 bits are necessary for indicate a 8TX rank 1 precoding matrix (W¹) from 8TX rank 1 codebook for 8TX UE with four coherent antenna groups.

A second sub-embodiment of the first embodiment relates to 8TX rank 2 codebook for 8TX UE with four coherent antenna groups, which includes 8TX rank 2 precoding matrices (W²), each of which is constructed using two 2TX rank 1 full coherent precoding matrices.

For rank 2 with two layers, each of the two layers is transmitted by one of the four antenna groups (i.e., only two of W₀~W₃ are non-zero), while the other two antenna groups are not used for transmission (i.e., the other two of W₀~W₃ is zero). There are

$$( \begin{matrix}4 \\ 2\end{matrix} ) = 6$$

different combinations of two antenna groups. In addition, the indicated two antenna groups can select two different precoding matrices from

$$2 {G}_{2}^{1}$$

with

$$( \begin{matrix}4 \\ 2\end{matrix} ) = 6$$

different combinations if it is assumed that a first selected precoding matrix (i.e., one of the two selected precoding matrices that has a lower index) is applied to a first indicated antenna group (i.e., one of the two indicated antenna groups that has a lower index); and a second selected precoding matrix (i.e., one of the two selected precoding matrices that has a higher index) is applied to a second indicated antenna group (i.e., one of the two indicated antenna groups that has a higher index). So, there are 36=6×6 different 8TX rank 2 precoding matrices (W²) in 8TX rank 2 codebook for 8TX UE with four coherent antenna groups. It requires ┌log₂(36)┐(=6) bits to indicate one of 36 precoding matrices.

To reduce signaling overhead, some of the 36 precoding matrices can be removed. For example, if 4 of the 36 precoding matrices are removed, only 32 precoding matrices remain in the codebook for 8TX rank 2 precoding matrices (W^{2R}) for 8TX UE with four coherent antenna groups. It will require ┌log₂(32)┐(=5) bits to indicate one of 32 precoding matrices.

A third sub-embodiment of the first embodiment relates to 8TX rank 3 codebook for 8TX UE with four coherent antenna groups, which includes 8TX rank 3 precoding matrices (W³), each of which is constructed using three 2TX rank 1 full coherent precoding matrices.

For rank 3 with three layers, each of the three layers is transmitted by one of the four antenna groups (i.e., three of W₀~W₃ are non-zero), while the other one antenna group is not used for transmission (i.e., the other one of W₀~W₃ is zero). There are

$$( \begin{matrix}4 \\ 3\end{matrix} ) = 4$$

different combinations of three antenna groups. In addition, the indicated three antenna groups can select three different precoding matrices from

$$2 {G}_{2}^{1}$$

with

$$( \begin{matrix}4 \\ 3\end{matrix} ) = 4$$

different combinations if it is assumed that a first selected precoding matrix (i.e., one of the three selected precoding matrices that has the lowest index) is applied to a first indicated antenna group (i.e., one of the three indicated antenna groups that has the lowest index); a second selected precoding matrix (i.e., one of the three selected precoding matrices that has the second lowest index) is applied to a second indicated antenna group (i.e., one of the three indicated antenna groups that has the second lowest index); and a third selected precoding matrix (i.e., one of the three selected precoding matrices that has the highest index) is applied to a third indicated antenna group (i.e., one of the three indicated antenna groups that has the highest index). So, there are 16=4×4 different 8TX rank 3 precoding matrices (W³) in 8TX rank 3 codebook for 8TX UE with four coherent antenna groups. It requires ┌log₂(16)┐(=4) bits to indicate one of 16 precoding matrices.

A fourth sub-embodiment of the first embodiment relates to 8TX rank 4 codebook for 8TX UE with four coherent antenna groups, which includes 8TX rank 4 precoding matrix (W⁴), which is constructed using four 2TX rank 1 full coherent precoding matrices.

For rank 4 with four layers, each of the four layers is transmitted by one antenna group. In addition, all four precoding matrices in

$$2 {G}_{2}^{1}$$

are used. In particular, the first precoding matrix

$$( \frac{1}{\sqrt{2}} [ \begin{matrix}1 \\ 1\end{matrix} ] ) ,$$

the second precoding matrix

$$( \frac{1}{\sqrt{2}} [ \begin{matrix}1 \\ - 1\end{matrix} ] ) ,$$

the third precoding matrix

$$( \frac{1}{\sqrt{2}} [ \begin{matrix}1 \\ j\end{matrix} ] )$$

and the fourth precoding matrix

$$( \frac{1}{\sqrt{2}} [ \begin{matrix}1 \\ - j\end{matrix} ] )$$

in

$${G}_{2}^{1}$$

are applied to the first antenna group, the second antenna group, the third antenna group and the fourth antenna group in a sequential manner, that is, they are used in a sequential manner as W₀, W₁, W₂ and W₃, respectively. So, the 8TX rank 4 precoding matrix (W⁴) is fixed as

$${W}^{4} = a [ \begin{matrix}1 & 0 & 0 & 0 \\ 1 & 0 & 0 & 0 \\ 0 & 1 & 0 & 0 \\ 0 & - 1 & 0 & 0 \\ 0 & 0 & 1 & 0 \\ 0 & 0 & j & 0 \\ 0 & 0 & 0 & 1 \\ 0 & 0 & 0 & - j\end{matrix} ] ,$$

where a is a normalization factor, such as

$$\frac{1}{2 \sqrt{2}} .$$

No explicit indication is necessary to indicate the only one 8TX rank 4 precoding matrix in 8TX rank 4 codebook.

The above 8TX rank 4 precoding matrix (W⁴) is obtained by assuming the antenna ports numbering shown in FIG. 2(a) or 2(b).

FIGS. 3(a) and 3(b) illustrate another antenna ports numbering (e.g., a second antenna ports numbering) for antenna layout 3-a (i.e., 2×2) and antenna layout 3-b (i.e., 1×4), respectively. As shown in FIGS. 3(a) and 3(b), PG₀ includes antenna ports 0 and 4, PG₁ includes antenna ports 1 and 5, PG₂ includes antenna ports 2 and 6, and PG₃ includes antenna ports 3 and 7.

A comparison between FIG. 3(a) or 3(b) and FIG. 2(a) or 2(b) can reveal that the antenna port numbers in FIG. 3(a) or 3(b) are equivalent to changing the sequence of antenna ports 0, 1, 2, 3, 4, 5, 6, 7 of FIG. 2(a) or 2(b) to a sequence of antenna ports 0, 1, 4, 5, 2, 3, 6, 7 as in Table 1.

TABLE 1

| | | | | | | | | |
|---|---|---|---|---|---|---|---|---|
| FIG. 2(a) or 2(b) | 0 | 1 | 2 | 3 | 4 | 5 | 6 | 7 |
| FIG. 3(a) or 3(b) | 0 | 1 | 4 | 5 | 2 | 3 | 6 | 7 |

Each of the 8 antenna ports corresponds to one row of 8TX rank N (N is from 1 to 8) precoding matrix, e.g., W⁴. When the sequence of antenna ports 0, 1, 2, 3, 4, 5, 6, 7 changes to the sequence of antenna ports 0, 1, 4, 5, 2, 3, 6, 7, the corresponding rows of 8TX rank N (N is from 1 to 8) precoding matrix, e.g., W⁴, shall be changed with the same manner. That is, if the antenna ports numbering is shown as FIG. 3(a) or 3(b), the 8TX rank 4 precoding matrix becomes

$${W}^{4 ′} = a [ \begin{matrix}1 & 0 & 0 & 0 \\ 1 & 0 & 0 & 0 \\ 0 & 0 & 1 & 0 \\ 0 & 0 & j & 0 \\ 0 & 1 & 0 & 0 \\ 0 & - 1 & 0 & 0 \\ 0 & 0 & 0 & 1 \\ 0 & 0 & 0 & - j\end{matrix} ] ,$$

where a is a normalization factor. That is, row 2 of W⁴ (i.e., {0 1 0 0}) and row 4 of W⁴ (i.e., {0 0 1 0}) are swapped (i.e., in W⁴′, row 2 is {0 0 1 0} and row 4 is {0 1 0 0}), and row 3 of W⁴ (i.e., {0-1 0 0}) and row 5 of W⁴ (i.e., {0 0 j 0}) are swapped (i.e., in W⁴′, row 3 is {0 0 j 0} and row 5 is {0-1 0 0}). From another point of view, W⁴′ can be constructed from W⁴ according to sequence correspondence between the first antenna ports numbering and the second antenna ports numbering. In particular, row 0 of W⁴′ is row 0 of W⁴; row 1 of W⁴′ is row 1 of W⁴; row 2 of W⁴′ is row 4 of W⁴; row 3 of W⁴′ is row 5 of W⁴; row 4 of W⁴′ is row 2 of W⁴; row 5 of W⁴′ is row 3 of W⁴; row 6 of W⁴′ is row 6 of W⁴; and row 7 of W⁴′ is row 7 of W⁴.

A fifth sub-embodiment of the first embodiment relates to 8TX rank 5 codebook for 8TX UE with four coherent antenna groups, which includes 8TX rank 5 precoding matrices (W⁵), each of which is constructed using 2TX rank 1 full coherent precoding matrices.

For rank 5 with five layers, all four coherent antenna groups need to transmit, where one of the four coherent antenna groups transmits 2 layers and each of the other three coherent antenna groups transmit 1 layer. For the one coherent antenna group that transmits 2 layers, a rank 2 precoding matrix can be constructed by adding a 2TX rank 1 full coherent precoding matrix to the original 2TX rank 1 full coherent precoding matrix applied to the one coherent antenna group in the 8TX rank 4 precoding matrix (W⁴).

There are two channel coding codewords (e.g., CW0 and CW1) for rank 5, where CW0 is used in the first 2 layers and CW1 is used in the remaining 3 layers. Since it is better to transmit the 3 layers of CW1 from 2 coherent antenna groups, it is proposed to add a 2TX rank 1 full coherent precoding matrix w_{ad} to PG2 or PG3 as a second column of the 2TX rank 2 precoding matrix.

For example, if the 2TX rank 1 full coherent precoding matrix w_{ad}

$$\frac{1}{\sqrt{2}} [ \begin{matrix}1 \\ 1\end{matrix} ]$$

is added to PG₂, as a second column, based on the 2TX rank 1 full coherent precoding matrix W₂ (i.e.,

$$\frac{1}{\sqrt{2}} [ \begin{matrix}1 \\ j\end{matrix} ] )$$

in W⁴, a new rank 2 precoding matrix W₂ for PG2 becomes

$$[ \begin{matrix}1 & 1 \\ j & 1\end{matrix} ] ,$$

which is without normalization. Accordingly, the resulting 8TX rank 5 precoding matrix will become

$${W}^{5} = a [ \begin{matrix}1 & 0 & 0 & 0 & 0 \\ 1 & 0 & 0 & 0 & 0 \\ 0 & 1 & 0 & 0 & 0 \\ 0 & - 1 & 0 & 0 & 0 \\ 0 & 0 & 1 & 1 & 0 \\ 0 & 0 & j & 1 & 0 \\ 0 & 0 & 0 & 0 & 1 \\ 0 & 0 & 0 & 0 & - j\end{matrix} ] ,$$

where a is a normalization factor, by assuming the antenna ports numbering shown in FIG. 2(a) or 2(b).

The 8TX rank 5 precoding matrix(ices) based on other antenna ports numberings can be obtained in the same manner as above-described obtaining W⁴′ from W⁴ by rearranging the rows of W⁵.

In order to transmit 2 layers from a coherent antenna group, the new 2TX rank 1 full coherent precoding matrix w_{ad} should be different than the original 2TX rank 1 full coherent precoding matrix of the coherent antenna group in W⁴ (which is referred to restriction of ‘no identical rank 1 precoding matrix allowed for the same antenna group’). Because W⁴ is fixed,

$$\frac{1}{\sqrt{2}} [ \begin{matrix}1 \\ j\end{matrix} ]$$

cannot be added to PG₂, and

$$\frac{1}{\sqrt{2}} [ \begin{matrix}1 \\ - j\end{matrix} ]$$

cannot be added to PG₃. Accordingly, there are two antenna groups (PG₂ and PG₃) to be selected to add the new 2TX rank 1 full coherent precoding matrix w_{ad}; and for each of the selected antenna groups (PG₂ or PG₃), three candidate new 2TX rank 1 full coherent precoding matrices can be further selected considering the restriction of ‘no identical rank 1 precoding matrix allowed for the same antenna group’. So, there are 6=2×3 precoding matrices (W⁵) in 8TX rank 5 codebook for 8TX UE with four coherent antenna groups. It requires ┌log₂(6)┐(=3) bits to indicate one of 16 precoding matrices.

A reduced number of precoding matrices W^{5R} can be constructed by removing some precoding matrices from W⁵ to reduce the number of bits for indication.

A sixth sub-embodiment of the first embodiment relates to 8TX rank 6 codebook for 8TX UE with four coherent antenna groups, which includes 8TX rank 6 precoding matrices (W⁶), each of which is constructed using 2TX rank 1 full coherent precoding matrices.

For rank 6 with six layers, all four antenna groups need to transmit, where two of the four antenna groups transmit 2 layers and each of the other two antenna groups transmit 1 layer. For each of the two coherent antenna groups that transmit 2 layers, a rank 2 precoding matrix can be constructed by adding a 2TX rank 1 full coherent precoding matrix to the original 2TX rank 1 full coherent precoding matrix applied to the coherent antenna group in the 8TX rank 4 precoding matrix (W⁴).

There are two channel coding codewords (e.g., CW0 and CW1) for rank 6, where CW0 is used in the first 3 layers and CW1 is used in the remaining 3 layers. Accordingly, a first 2TX rank 1 full coherent precoding matrix w_{ad1} can be added to PG₀ or PG₁ as a second column; and a second 2TX rank 1 full coherent precoding matrix w_{ad2} can be added to PG₂ or PG₃ as a second column.

For the first three layers, one of two antenna groups (PG₀ and PG₁) can be selected to add the first 2TX rank 1 full coherent precoding matrix w_{ad1}; and for the last three layers, one of two antenna groups (PG₂ and PG₃) can be selected to add the second 2TX rank 1 full coherent precoding matrix w_{ad2}. The restriction of ‘no identical rank 1 precoding matrix allowed for the same antenna group’ (referred to as first restriction) still applies. It means that the first 2TX rank 1 full coherent precoding matrix w_{ad1} should be different than the original 2TX rank 1 full coherent precoding matrix of the coherent antenna group to which the first 2TX rank 1 full coherent precoding matrix w_{ad1} is added in W⁴; and the second 2TX rank 1 full coherent precoding matrix w_{ad2} should be different than the original 2TX rank 1 full coherent precoding matrix of the coherent antenna group to which the second 2TX rank 1 full coherent precoding matrix w_{ad2} is added in W⁴. In addition, a second restriction that all of added 2TX rank 1 full coherent precoding matrices are different is also applied. It means that the first 2TX rank 1 full coherent precoding matrix w_{ad1} is different from the second 2TX rank 1 full coherent precoding matrix w_{ad2}.

Accordingly, there are

$$( \begin{matrix}2 \\ 1\end{matrix} ) ( \begin{matrix}2 \\ 1\end{matrix} ) * ( 1 * 3 + 2 * 2 ) = 28$$

precoding matrices (W⁶) in 8TX rank 6 codebook for 8TX UE with four coherent antenna groups. It requires ┌log₂(28)┐(=5) bits to indicate one of 28 precoding matrices.

Among

$$( \begin{matrix}2 \\ 1\end{matrix} ) ( \begin{matrix}2 \\ 1\end{matrix} ) * ( 1 * 3 + 2 * 2 ) ,$$

the first

$$( \begin{matrix}2 \\ 1\end{matrix} )$$

means to select one of antenna groups PG₀ and PG₁; the second

$$( \begin{matrix}2 \\ 1\end{matrix} )$$

means to select one of antenna groups PG₂ and PG₃; and (1*3+2*2)=7 means that when one of antenna groups PG₀ and PG₁ is selected and one of antenna groups PG₂ and PG₃ is selected, there are 7 different combinations of w_{ad1} and w_{ad2} in consideration of the first restriction and the second restriction.

For example, if the four 2TX rank 1 full coherent precoding matrices are indexed as 0, 1, 2 and 3, and it is supposed that antenna group P_{G} and antenna groups PG₂ are selected, the candidate combinations of w_{ad1} and w_{ad2} are: (1, 0), (1, 3), (2, 0), (2, 1), (2, 3), (3,0) and (3, 1).

A reduced number of precoding matrices W^{6R} can be constructed by removing some precoding matrices from W⁶ to reduce the number of bits for indication.

A seventh sub-embodiment of the first embodiment relates to 8TX rank 7 codebook for 8TX UE with four coherent antenna groups, which includes 8TX rank 7 precoding matrices (W⁷), each of which is constructed using 2TX rank 1 full coherent precoding matrices.

For rank 7 with seven layers, all four antenna groups need to transmit, where each of three of the four antenna groups transmit 2 layers and the other one antenna group transmits 1 layer. For each of the three coherent antenna groups that transmit 2 layers, a rank 2 precoding matrix can be constructed by adding a 2TX rank 1 full coherent precoding matrix to the original 2TX rank 1 full coherent precoding matrix applied to the coherent antenna group in the 8TX rank 4 precoding matrix (W⁴).

There are two channel coding codewords (e.g., CW0 and CW1) for rank 7, where CW0 is used in the first 3 layers and CW1 is used in the remaining 4 layers. Accordingly, a first 2TX rank 1 full coherent precoding matrix w_{ad1} can be added to PG₀ or PG₁ as a second column; a second 2TX rank 1 full coherent precoding matrix W_{ad2} can be added to PG₂ as a second column; and a third 2TX rank 1 full coherent precoding matrix w_{ad3} can be added to PG₃ as a second column.

For the first three layers, one of two antenna groups (PG₀ and PG₁) can be selected to add the first 2TX rank 1 full coherent precoding matrix w_{ad1}. The first restriction (i.e., the restriction of ‘no identical rank 1 precoding matrix allowed for the same antenna group’) and the second restriction (i.e., the restriction that “all of added 2TX rank 1 full coherent precoding matrices are different”) still apply. It means that each of the first 2TX rank 1 full coherent precoding matrix w_{ad1}, the second 2TX rank 1 full coherent precoding matrix w_{ad2} and the third 2TX rank 1 full coherent precoding matrix w_{ad3} should be different than each original 2TX rank 1 full coherent precoding matrix of the coherent antenna group to which each of the first 2TX rank 1 full coherent precoding matrix w_{ad1}, the second 2TX rank 1 full coherent precoding matrix w_{ad2} and the third 2TX rank 1 full coherent precoding matrix w_{ad3} is added in W⁴; and that the first 2TX rank 1 full coherent precoding matrix w_{ad1}, the second 2TX rank 1 full coherent precoding matrix w_{ad2} and the third 2TX rank 1 full coherent precoding matrix w_{ad3} are also different.

Accordingly, there are

$$( \begin{matrix}2 \\ 1\end{matrix} ) * ( A ( 3 , 3 ) + 3 * 3 ) = 2 * ( 2 + 3 * 3 ) = 22$$

precoding matrices (W⁷) in 8TX rank 7 codebook for 8TX UE with four coherent antenna groups. It requires ┌log₂(22)┐(=5) bits to indicate one of 22 precoding matrices.

$$( \begin{matrix}2 \\ 1\end{matrix} )$$

means to select one of antenna groups PG₀ and PG₁.

A(3,3)+3*3=11 means that when one of antenna groups PG₀ and PG₁ is selected, there are 11 different combinations of w_{ad1}, w_{ad2} and w_{ad3} in consideration of the first restriction and the second restriction.

A(n,n) (where n is any one of 1 to 4) indicates the number of permutations of (0, 1, . . . , n−1) where no number is in its original position. For example, if n=4, the original position is (0, 1, 2, 3). According to this definition, (1, 2, 3, 0) is allowed while (1, 2, 0, 3) is disallowed (since 3 is in its original position). It is easy to derive that A(1, 1)=0 and A(2, 2)=1 (i.e., original position is (0, 1), the only allowed permutation is (1, 0)). A(n,n) can be derived from

$$A ( n , n ) = n ! - {\sum }_{i = 1}^{n} ( \begin{matrix}n \\ i\end{matrix} ) A ( n - i , n - i ) .$$

So, A(3, 3)=2 and A(4, 4)=9 can be derived.

For example, it is supposed that antenna group PG₀ is selected, the candidate combinations of w_{ad1}, w_{ad2} and w_{ad3} are:
(2, 3, 0), (3, 0, 2),
(1, 0, 2), (2, 0, 1), (2, 1, 0),
(1, 3, 0), (3, 0, 1), (3, 1, 0),
(2, 3, 1), (3, 1, 2), (1, 3, 2)

Similarly, if antenna group PG₁ is selected, the candidate combinations of w_{ad1}, w_{ad2} and w_{ad3} are:
(2, 3, 1), (3, 1, 2),
(0, 1, 2), (2, 1, 0), (2, 0, 1),
(0, 3, 1), (3, 1, 0), (3, 0, 1),
(2, 3, 0), (3, 0, 2), (0, 3, 2)

A reduced number of precoding matrices W^{7R} can be constructed by removing some precoding matrices from W⁷ to reduce the number of bits for indication.

An eighth sub-embodiment of the first embodiment relates to 8TX rank 8 codebook for 8TX UE with four coherent antenna groups, which includes 8TX rank 8 precoding matrices (W⁸), each of which is constructed using 2TX rank 1 full coherent precoding matrices.

For rank 8 with eight layers, all four antenna groups need to transmit, where each of the four antenna groups transmits 2 layers. For each of the four coherent antenna groups that transmit 2 layers, a rank 2 precoding matrix can be constructed by adding a 2TX rank 1 full coherent precoding matrix to the original 2TX rank 1 full coherent precoding matrix applied to the coherent antenna group in the 8TX rank 4 precoding matrix (W⁴)

There are two channel coding codewords (e.g., CW0 and CW1) for rank 8, where CW0 is used in the first 4 layers and CW1 is used in the remaining 4 layers. Accordingly, a first 2TX rank 1 full coherent precoding matrix w_{ad1} is added to PG₀ as a second column; a second 2TX rank 1 full coherent precoding matrix w_{ad2} is added to PGᵢ as a second column; a third 2TX rank 1 full coherent precoding matrix w_{ad3} is added to PG₂ as a second column; and a fourth 2TX rank 1 full coherent precoding matrix w_{ad4} can be added to PG₃ as a second column.

The first restriction (i.e., the restriction of ‘no identical rank 1 precoding matrix allowed for the same antenna group’) and the second restriction (i.e., the restriction that “all of added 2TX rank 1 full coherent precoding matrices are different”) still apply.

Since all 4 antenna groups need to transmit two layers, there is no need to indicate the antenna groups. There are A(4,4)=9 precoding matrices (W⁸) in 8TX rank 8 codebook for 8TX UE with four coherent antenna groups. It requires ┌log₂(9)┐(=4) bits to indicate one of 9 precoding matrices.

A(4,4)=9 means that there are 9 different combinations of w_{ad1}, w_{ad2}, w_{ad3}, and w_{ad4} in consideration of the first restriction and the second restriction.

The candidate combinations of w_{ad1}, w_{ad2}, w_{ad3}, and w_{ad4} are:
(1, 0, 3, 2), (2, 3, 0, 1), (3, 2, 1, 0),
(2, 0, 3, 1), (1, 2, 3, 0), (3, 0, 1, 2),
(1, 3, 0, 2), (2, 3, 1, 0), (3, 2, 0, 1)

A reduced number of precoding matrices W^{8R} can be constructed by removing some precoding matrices from W⁸ to reduce the number of bits for indication.

As a whole, according to the first embodiment, 8TX rank N (N is from 1 to 8) codebook for 8TX UE with four coherent antenna groups is constructed based on 2TX rank 1 full coherent precoding matrices.

For rank N where N is 1 to 4, N antenna ports are used for transmission, where each antenna port transmits 1 layer with one 2TX rank 1 full coherent precoding matrix.

For rank N where N is 5 to 8, additional N-4 2TX rank 1 full coherent precoding matrices are indicated for N-4 antenna groups to allow each of them to transmit 2 layers. In addition, a first restriction is made so that when an antenna group is assigned with two 2TX rank 1 full coherent precoding matrices, the two 2TX rank 1 full coherent precoding matrices are different. Moreover, a second restriction is made so that all of the additional N-4 2TX rank 1 full coherent precoding matrices are different.

According to the first embodiment, each of CW0 and CW1 is transmitted from only 2 antenna groups.

Each of the above mechanisms limit the size of the 8TX rank N (N is from 1 to 8) codebook, to reduce the computation and signaling overhead.

According to a second embodiment, the precoding matrices in NR Release 15 4TX ranks 1 to 4 codebooks can be used to construct each of W₀, W₁, W₂ and W₃.

First, the antenna ports numbering described with reference to FIG. 2(a) and FIG. 2(b) is further explained. Each of FIGS. 2(a) and 2(b) illustrate the first antenna ports numbering, in which a first antenna group PG₀ includes antenna ports 0 and 2, a second antenna group PG₁ includes antenna ports 1 and 3, a third antenna group PG₂ includes antenna ports 4 and 6, and a fourth antenna group PG₃ includes antenna ports 5 and 7. In the second embodiment, the antenna ports numbering further includes a concept of antenna group pair. As shown in FIGS. 2(a) and 2(b), the first antenna group PG₀ and the second antenna group PG₁ form a first antenna group pair, and the third antenna group PG₂ and the fourth antenna group PG₃ form a second antenna group pair.

In the condition that the transmitted information (modulation symbol) X of length r is split into

$$X = [ \begin{matrix}{X}_{01} \\ {X}_{23}\end{matrix} ] ,$$

in which r r₁+r₂, 1≤r₁≤4 and 1≤r₂≤4,

$${W}_{01} = [ \begin{matrix}{W}_{0} \\ {W}_{1}\end{matrix} ] , and$$

$${W}_{23} = [ \begin{matrix}{W}_{2} \\ {W}_{3}\end{matrix} ] ,$$

$${Y}^{′} = [ {H}_{0} {H}_{1} {H}_{2} {H}_{3} ] [ \begin{matrix}{W}_{0} & 0 \\ {W}_{1} & 0 \\ 0 & {W}_{2} \\ 0 & {W}_{3}\end{matrix} ] [ \begin{matrix}{X}_{01} \\ {X}_{23}\end{matrix} ] + N = [ {H}_{0} {H}_{1} {H}_{2} {H}_{3} ] [ \begin{matrix}{W}_{01} & 0 \\ 0 & {W}_{23}\end{matrix} ] [ \begin{matrix}{X}_{01} \\ {X}_{23}\end{matrix} ] + N = [ {H}_{0} {H}_{1} ] {W}_{01} {X}_{01} + [ {H}_{2} {H}_{3} ] {W}_{23} {X}_{23} + N = [ {H}_{0} {H}_{1} ] [ \begin{matrix}{W}_{0} \\ {W}_{1}\end{matrix} ] {X}_{01} + [ {H}_{2} {H}_{3} ] [ \begin{matrix}{W}_{2} \\ {W}_{3}\end{matrix} ] {X}_{23} + N .$$

If X₀=X₁=X₀₁, a same signal is transmitted by two antenna groups (i.e., an antenna group pair) in a layer, a modulation symbol vector X₀₁ of length r₁ (1≤r₁≤4) is transmitted from a first antenna group pair (e.g., PG₀ and PG₁ shown in FIGS. 2(a) and 2(b)). Based on

$${W}_{01} = [ \begin{matrix}{W}_{0} \\ {W}_{1}\end{matrix} ] ,$$

a 4TX precoder (i.e., precoding matrix) with rank=r₁ that has a size of 4 by r₁ (i.e., 4 rows and r₁ columns) (e.g., W₀₁) can be decomposed into a pair of 2TX precoding matrices each having a size of 2 by r₁ (i.e., 2 rows and r₁ columns) (e.g., W₀ and W₁). It means that the precoding matrix of each antenna group in the first antenna group pair can be derived from such decomposition. For example, the first two rows of W₁ can be used as the precoding matrix W₀ of the first antenna group PG₀ in the first antenna group pair; and the last two rows of W₀₁ can be used as the precoding matrix W₁ of the second antenna group PG₁ in the first antenna group pair.

Incidentally, although X₀=X₁=X₀₁, X₀₁ is transmitted in both PG₀ and PG₁, instead of PG₀ and PG₁ each transmitting half the layer of X₀₁. This is because all the layers of X₀₁ are transmitted in the ports of PG₀ and PG₁.

Similarly, if X₂=X₃=X₂₃, a same signal is transmitted by two antenna groups (i.e., an antenna group pair) in a layer, a modulation symbol vector X₂₃ of length r₂ (1≤r₂≤4) is transmitted from a second antenna group pair (e.g., PG₂ and PG₃ shown in FIGS. 2(a) and 2(b)). Based on

$${W}_{23} = [ \begin{matrix}{W}_{2} \\ {W}_{3}\end{matrix} ] ,$$

a 4TX precoder (i.e., precoding matrix) with rank=r₂ that has a size of 4 by r₂ (i.e., 4 rows and r₂ columns) (e.g., W₂₃) can be decomposed into a pair of 2TX precoding matrices each has a size of 2 by r₂ (i.e., 2 rows and r₁ columns) (e.g., W₂ and W₃). It means that the precoding matrix of each antenna group in the second antenna group pair can be derived from such decomposition. For example, the first two rows of W₂₃ can be used as the precoding matrix W₂ of the first antenna group PG₂ in the second antenna group pair; and the last two rows of W₂₃ can be used as the precoding matrix W₃ of the second antenna group PG₃ in the second antenna group pair.

Incidentally, although X₂=X₃=X₂₃, X₂₃ is transmitted in both PG₂ and PG₃, instead of PG₂ and PG₃ each transmitting half the layer of X₂₃. This is because all the layers of X₂₃ are transmitted in the ports of PG₂ and PG₃.

In the following description, for transmission with rank r=r₁+r₂, r₁ represents the number of layers transmitted in the first antenna group pair (e.g., including PG₀ and PG₁, and r₂ represents the number of layers transmitted in the second antenna group pair (e.g., including PG₂ and PG₃).

Based on the above analysis, the second embodiment proposes that one precoding matrix in NR Release 15 4TX rank N (N=1 to 4) codebook can be decomposed into two 2TX rank N precoding matrices each of which is used as the precoding matrix of one antenna group in an antenna group pair.

The precoding matrices in these NR Release 15 4TX codebooks can be classified into different types based on their structures (that is, the number of actively transmitting antenna ports and their relative phases).

In this disclosure, the 4TX precoding matrices for each rank k can be classified into three groups. The 4TX precoding matrices with each rank k in each of the three groups are of the same type. It means that each 4TX precoding matrix with each rank k can be of one of three types, e.g., type #1, type #2 and type #3. The notion

$${G}_{t}^{k}$$

represents a group of 4TX precoding matrices with rank k and type t. The notion G^{k} represents all the 4TX precoding matrices with rank k, that is, the 4TX precoding matrices with rank k with all types.

4TX rank 1 codebook is given by Table 6.3.1.5-2 (for DFT-s-OFDM) or Table 6.3.1.5-3 (for CP-OFDM) specified in 3GPP Technical Specification TS38.211 V16.0.0 as follows:

TABLE 6.3.1.5-2
Precoding matrix W for single-layer transmission using four antenna
ports with transform precoding enabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 6.3.1.5-3
Precoding matrix W for single-layer transmission using four antenna
ports with transform precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $[ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

The 4TX rank 1 precoding matrices (with TPMI index from 0 to 27) can be classified into three groups:

A first group with Type #1:

$${G}_{1}^{1}$$

includes precoding matrices with indices of 0 to 3 (i.e., {TPMI indices 0-3}): port selection precoding matrices, that is, one port is selected out of 4 ports for transmission.

A second group with Type #2:

$${G}_{2}^{1}$$

includes precoding matrices with indices of 4 to 11 (i.e., {TPMI indices 4-11}): port-selection and co-phasing precoding matrices, that is, a pair of antenna ports are selected for transmission and a co-phasing factor is applied to them.

A third group with Type #3:

$${G}_{3}^{1}$$

includes precoding matrices with indices of 12 to 27 (i.e., {TPMI indices 12-27}): four ports co-phasing precoding matrices, that is, all four ports are used for transmission and a co-phasing vector is applied to them.

It can be seen that

$${G}_{2}^{1} = \{ TDMI indices 4 - 11 \}$$

are partial coherent precoding matrices. It means that for each of 4TX rank 1 precoding matrices with TPMI indices 4-11, two antenna ports are selected out of 4 antenna ports (i.e., there are two non-zero elements among the four elements in the column) and a co-phasing factor is applied to them. When each of 4TX rank 1 precoding matrices with TPMI indices 4-11 is decomposed to two 2TX rank 1 precoding matrices, if the two non-zero elements are in the same 2TX rank 1 precoding matrix, it can be used without performance loss.

For antenna group 0 (PG₀) and antenna group 1 (PG₁) as shown in FIG. 2(a) or 2(b) that include four antenna ports [0, 1, 2, 3], antenna ports [0, 2] belong to antenna group 0 and are coherent; antenna ports [1, 3] belong to antenna group 1 and are coherent. Each of the 4TX rank 1 precoding matrices with TPMI indices 4-7 use only antenna ports in antenna group 0 (PG₀) (i.e., antenna ports [0, 2]); and each of the 4TX rank 1 precoding matrices with TPMI indices 8-11 use only antenna ports in antenna group 1 (PG₁) (i.e., antenna ports [1, 3]).

Therefore, these precoding matrices (the 4TX rank 1 precoding matrices with TPMI indices 4-11 in Table 6.3.1.5-2 (for DFT-s-OFDM) or Table 6.3.1.5-3 (for CP-OFDM)) can be used to PG₀ and PG₁ without performance loss, even if the two antenna groups (PG₀ and PG₁) are not coherent to each other.

Similarly, for antenna group 2 (PG₂) and antenna group 3 (PG₃) as shown in FIG. 2(a) or 2(b) that include four antenna ports [4, 5, 6, 7], antenna ports [4, 6] belong to antenna group 2 and are coherent; antenna ports [5, 7] belong to antenna group 3 and are coherent. Each of the 4TX rank 1 precoding matrices with TPMI indices 4-7 use only antenna ports in antenna group 2 (PG₂) (i.e., antenna ports [4, 6]); and each of the 4TX rank 1 precoding matrices with TPMI indices 8-11 use only antenna ports in antenna group 3 (i.e., antenna ports [5, 7]). Therefore, these precoding matrices (the 4TX rank 1 precoding matrices with TPMI indices 4-11 in Table 6.3.1.5-2 (for DFT-s-OFDM) or Table 6.3.1.5-3 (for CP-OFDM)) can be used to PG₂ and PG₃ without performance loss, even if the two antenna groups (PG₂ and PG₃) are not coherent to each other

As a whole, each of the 4TX Rank 1 precoding matrices (in Table 6.3.1.5-2 (for DFT-s-OFDM) or Table 6.3.1.5-3 (for CP-OFDM)) in

$${G}_{2}^{1} = \{ TDMI indices 4 - 11 \}$$

can be decomposed to 2 2TX Rank 1 precoding matrices, each of which can be used as the precoding matrix of one antenna group for each antenna group pair (e.g., a first antenna group pair including PG₀ and PG₁, or a second antenna group pair including PG₂ and PG₃).

4TX rank 2 codebook is given by Table 6.3.1.5-5 specified in 3GPP Technical Specification TS38.211 V16.0.0 as follows:

TABLE 6.3.1.5-5
Precoding matrix W for two-layer transmission using four antenna ports with
transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

The rank 2 precoding matrices (G², with TPMI index from 0 to 21) can be classified into three groups:

A first group with Type #1:

$${G}_{1}^{2}$$

includes precoding matrices with indices of 0 to 5 (i.e., {TPMI indices 0-5}): port selection precoding matrices.

A second group with Type #2:

$${G}_{2}^{2}$$

includes precoding matrices with indices of 6 to 13 (i.e., {TPMI indices 6-13}): port-selection and co-phasing precoding matrices.

A third group with Type #3:

$${G}_{3}^{2}$$

includes precoding matrices with indices of 14 to 21 (i.e., {TPMI indices 14-21}): four ports co-phasing precoding matrices.

$${G}_{2}^{2} = \{ TDMI indices 6 - 13 \}$$

are partial coherent precoding matrices. For each of 4TX rank 2 precoding matrices with TPMI indices 6-13, each layer is transmitted by two antenna ports (i.e., there are two non-zero elements among the four elements in each column). The two antenna ports in each column used to transmit one layer, that are antenna ports [0, 2] or antenna ports [1, 3]), are in a same antenna group. So, there is no performance loss when these precoding matrices (the 4TX rank 2 precoding matrices with TMPI indices 6-13 in Table 6.3.1.5-5) are decomposed to 2 2TX rank 2 precoding matrices, each of which is used as the precoding matrix of one antenna group for each antenna group pair (e.g., a first antenna group pair including PG₀ and PG₁, or a second antenna group pair including PG₂ and PG₃). As a whole, each of the 4TX Rank 2 precoding matrices (in Table 6.3.1.5-5) in

$${G}_{2}^{2} = \{ TDMI indices 6 - 13 \}$$

can be decomposed to 2 2TX Rank 2 precoding matrices, each of which can be used as the precoding matrix of one antenna group for each antenna group pair.

4TX rank 3 codebook is given by Table 6.3.1.5-6 specified in 3GPP Technical Specification TS38.211 V16.0.0 as follow:

TABLE 6.3.1.5-6
Precoding matrix W for three-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

The rank 3 precoding matrices (G³, with TPMI index from 0 to 6) can be classified into three groups:

A first group with Type #1:

$${G}_{1}^{3}$$

includes precoding matrices with index of 0 (i.e., {TPMI index 0}: port selection precoding matrices.

A second group with Type #2:

$${G}_{2}^{3}$$

includes precoding matrices with indices of 1 to 2 (i.e., {TPMI indices 1-2}: port-selection and co-phasing precoding matrices.

A third group with Type #3:

$${G}_{3}^{3}$$

includes precoding matrices with indices of 3 to 6 (i.e., {TPMI indices 3-6}: four ports co-phasing precoding matrices.

$${G}_{2}^{3} = \{ TDMI indices 1 - 2 \}$$

are partial coherent precoding matrices. For each of 4TX rank 3 precoding matrices with TPMI indices 1-2, two antenna ports in an antenna group (e.g., including antenna ports [0, 2]) are used to transmit a first layer with different co-phasing factors, while each of the two antenna ports in another antenna group (e.g., including antenna ports [1, 3]) transmits one layer (e.g., a second layer and a third layer). Because no layer is transmitted using two antenna ports from different antenna groups, there is no performance degradation when these precoding matrices (the 4TX rank 3 precoding matrices with TMPI indices 1-2 in Table 6.3.1.5-6) are decomposed to 2 2TX rank 3 precoding matrices, each of which is used as the precoding matrix of one antenna group for each antenna group pair (e.g., a first antenna group pair including PG₀ and PG₁, or a second antenna group pair including PG₂ and PG₃). As a whole, each of the 4TX Rank 3 precoding matrices (in Table 6.3.1.5-6) in

$${G}_{2}^{3} = \{ TPMI indices 1 - 2 \}$$

can be decomposed to 2 2TX Rank 3 precoding matrices, each of which can be used as the precoding matrix of one antenna group for each antenna group pair.

4TX rank 4 codebook is given by Table 6.3.1.5-7 specified in 3GPP Technical Specification TS38.211 V16.0.0 as follow:

TABLE 6.3.1.5-7
Precoding matrix W for four-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 0 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The rank 4 precoding matrices (G⁴, with TPMI index from 0 to 4) can be classified into three groups:

A first group with Type #1:

$${G}_{1}^{4}$$

includes precoding matrices with index of 0 (i.e., {TPMI index 0}): port selection precoding matrices.

A second group with Type #2:

$${G}_{2}^{4}$$

includes precoding matrices with indices of 1 to 2 (i.e., {TPMI indices 1-2}): port-selection and co-phasing precoding matrices.

A third group with Type #3:

$${G}_{3}^{4}$$

includes recoding matrices with indices of 3 to 6 (i.e., {TPMI indices 3-6}: four ports co-phasing precoding matrices.

$${G}_{2}^{4} = \{ TPMI indices 1 - 2 \}$$

are partial coherent precoding matrices. Two antenna ports in an antenna group (e.g., including antenna ports [0, 2]) are used to transmit two layers (e.g., a first layer and a second layer) with different co-phasing factors, while the two antenna ports in another group (e.g., including antenna ports [1, 3]) are used to transmit two other layers (e.g., a third layer and a fourth layer) with different co-phasing factors. Because no layer is transmitted using two ports from different antenna groups, there is no performance degradation when these precoding matrices (the 4TX rank 4 precoding matrices with TMPI indices 1-2 in Table 6.3.1.5-7) are decomposed to 2 2TX rank 4 precoding matrices, each of which is used as the precoding matrix of one antenna group for each antenna group pair (e.g., a first antenna group pair including PG₀ and PG₁, or a second antenna group pair including PG₂ and PG₃). As a whole, each of the 4TX Rank 4 precoding matrices (in Table 6.3.1.5-7) in

$${G}_{2}^{4} = \{ TPMI indices 1 - 2 \}$$

can be decomposed to 2 2TX Rank 4 precoding matrices, each of which can be used as the precoding matrix of one antenna group for each antenna group pair.

As a whole, all the 4TX rank N (N is 1 to 4) precoding matrices each of which can be decomposed to 2 2TX rank N precoding matrices, each of which can be used as the precoding matrix of one antenna group for each antenna group pair, are listed in Table 2:

TABLE 2

| | |
|---|---|
| Rank 1 | ${G}_{2}^{1} : 4 TX rank 1 precoding matrices in Table 6.3 \text{.1} \text{.5} - 2 or Table 6.3 \text{.1} \text{.5} - 3 with TPMI$ |
| | indices 4-11, with a total of 8 precoding matrices |
| Rank 2 | ${G}_{2}^{2} : 4 TX rank 2 precoding matrices in Table 6.3 \text{.1} \text{.5} - 5 with TPMI indices 6 - 13 , with$ |
| | a total of 8 precoding matrices |
| Rank 3 | ${G}_{2}^{3} : 4 TX rank 3 precoding matrices in Table 6.3 \text{.1} \text{.5} - 6 with TPMI indices 1 - 2 , with$ |
| | a total of 2 precoding matrices |
| Rank 4 | ${G}_{2}^{4} : 4 TX rank 4 precoding matrices in Table 6.3 \text{.1} \text{.5} - 7 with TPMI indices 1 - 2 , with$ |
| | a total of 2 precoding matrices |

The second embodiment proposes 8TX rank N precoding matrices, where N is from 1 to 8, for 8TX UE (UE with 8 antenna ports) with four coherent antenna groups, using 4TX rank N (N is 1 to 4) precoding matrices listed in Table 2.

The second embodiment will be described by taking the first antenna ports numbering shown in FIG. 2(a) or 2(b) as the antenna ports numbering. That is, PG₀ includes antenna ports 0 and 2, PG₁ includes antenna ports 1 and 3, and PG₀ and PG₁ are a first antenna group pair associated with precoding matrix

$${W}_{01} = [ \begin{matrix}{W}_{0} \\ {W}_{1}\end{matrix} ] ,$$

in which W₀ is the precoding matrix for PG₀(i.e., for antenna ports 0 and 2), W₁ is the precoding matrix for PG₁(i.e., for antenna ports 1 and 3). PG₂ includes antenna ports 4 and 6, PG₃ includes antenna ports 5 and 7, and PG₂ and PG₃ are a second antenna group pair associated with precoding matrix

$${W}_{23} = [ \begin{matrix}{W}_{2} \\ {W}_{3}\end{matrix} ] ,$$

in which W₂ is the precoding matrix for PG₂ (i.e., for antenna ports 4 and 6), W₃ is the precoding matrix for PG₃ (i.e., for antenna ports 5 and 7).

A first sub-embodiment of the second embodiment relates to 8TX rank 1 codebook for 8TX UE with four coherent antenna groups, which includes 8TX rank 1 precoding matrices (W′), each of which is constructed using one of two 4TX rank 1 partial coherent precoding matrices.

For rank 1, one layer is transmitted by only one antenna group (i.e., by two antenna ports in the one antenna group). To fully utilize four antenna groups, any one of the four antenna groups should be able to transmit the one layer. It means that W₀₁ is assigned to the first antenna group pair (which implies that 0 is assigned to the second antenna group pair) (i.e., the 8×1 precoding vector takes the form

$${W}^{1} = \frac{1}{2} [ \begin{matrix}{W}_{01} \\ 0\end{matrix} ] ,$$

where W₀₁ ∈

$${W}_{01} ∈ {G}_{2}^{1} ,$$

denoted as ‘1+0’) or W₂₃ is assigned to the second antenna group pair (which implies that 0 is assigned to the first antenna group pair) (i.e., the 8×1 precoding vector takes the form

$${W}^{1} = \frac{1}{2} [ \begin{matrix}0 \\ {W}_{23}\end{matrix} ] ,$$

where W₂₃ ∈

$${W}_{23} ∈ {G}_{2}^{1} , denoted as ‘ 0 + 1 ’ ) .$$

1 bit is used to indicate whether W₀₁ is assigned to the first antenna group pair or W₂₃ is assigned to the second antenna group pair (i.e., whether the precoding matrix (or precoding vector) takes the form

$${W}^{1} = \frac{1}{2} [ \begin{matrix}{W}_{01} \\ 0\end{matrix} ]$$

or the form

$${W}^{1} = \frac{1}{2} [ \begin{matrix}0 \\ {W}_{23}\end{matrix} ] .$$

3 bits can be used to indicate which one of the 8 4TX rank 1 partial coherent precoding matrices

$$( i . e . , {G}_{2}^{1} = \{ TPMI indices 4 - 11 \} )$$

is used in the indicated W₀₁ or W₂₃. As a whole, 4 bits are necessary to indicate a 8TX rank 1 precoding matrix (W¹) for 8TX UE with four coherent antenna groups using one of two 4TX rank 1 partial coherent precoding matrices.

Since any partial coherent precoding matrix from

$${G}_{2}^{1}$$

only uses 2 antenna ports from one port antenna group, any 1 of the 4 antenna groups can be used to transmit the one layer with any one of

$$\frac{1}{2} [ \begin{matrix}1 \\ 1\end{matrix} ] , \frac{1}{2} [ \begin{matrix}1 \\ - 1\end{matrix} ] , \frac{1}{2} [ \begin{matrix}1 \\ j\end{matrix} ] and \frac{1}{2} [ \begin{matrix}1 \\ - j\end{matrix} ] .$$

Incidentally, the 4TX rank 1 precoding matrices with TPMI indices 4-11 are the same (for the same index) in Table 6.3.1.5-2 (for DFT-s-OFDM) and in Table 6.3.1.5-3 (for CP-OFDM).

A second sub-embodiment of the second embodiment relates to 8TX rank 2 codebook for 8TX UE with four coherent antenna groups, which includes 8TX rank 2 precoding matrices (W²), each of which is constructed using two 4TX rank 1 partial coherent precoding matrices.

For rank 2 with two layers (e.g., a first layer and a second layer), each of the two layers is transmitted by one antenna group pair. That is, the first layer is transmitted by the first antenna group pair (e.g., including PG_{O} and PG₁), and the second layer is transmitted by the second antenna group pair (e.g., including PG₂ and PG₃), which is referred to as “1+1”. The 8×2 precoding matrix takes the form

$${W}^{2} = \frac{1}{\sqrt{2}} [ \begin{matrix}{W}_{01} & 0 \\ 0 & {W}_{23}\end{matrix} ] ,$$

where

$${W}_{01} ∈ {G}_{2}^{1} , and {W}_{23} ∈ {G}_{2}^{1} .$$

So, the 8TX rank 2 codebook includes a total of

$$\vert {W}^{2} \vert = \vert {G}_{2}^{1} \vert \vert {G}_{2}^{1} \vert = 8 * 8 = 64$$

8TX rank 2 precoding matrices. As a result, the first layer is transmitted by one of antenna groups PG₀ and PG₁ of the first antenna group pair, and the second layer is transmitted by one of antenna groups PG₂ and PG₃ of the second antenna group pair.

It is possible to reduce the size of the codebook by only allowing certain combinations of (W₀₁, W₂₃) to obtain a reduced 8TX rank 2 codebook W^{2R}. For example, if it is not allowed to use the same 4TX rank 1 partial coherent precoding matrix

$${W}_{01} ∈ {G}_{2}^{1} and$$

$${W}_{23} ∈ {G}_{2}^{1}$$

(i.e., it is required that W₀₁≠W₂₃), a total number of precoding matrices for the reduced codebook W^{2R} will become |W²|−8=56.

Joint TPMI indication or separate TPMI indication can be used to indicate a 8TX rank 2 precoding matrix from W² or W^{2R}.

If a 8TX rank 2 precoding matrix is indicated from W² or W^{2R} by a joint TPMI indication, each state represents a combination of (W₀₁, W₂₃). In the condition of W², it requires ┌log₂(64)┐(=6) bits to indicate one of 64 precoding matrices.

If a 8TX rank 2 precoding matrix is indicated from W² or W^{2R} by a separate TPMI indication, W₀₁ and W₂₃ are separately indicated. In the condition of W², it requires ┌log₂(8)┐(=3) bits to indicate one of 8 precoding matrices from

$${G}_{2}^{1}$$

for W₀₁, and it requires ┌log₂(8)┐(=3) bits to indicate one of 8 precoding matrices from

$${G}_{2}^{1}$$

for W₂₃. That is, a total of 6 bits are necessary for separate TPMI indication.

A third sub-embodiment of the second embodiment relates to 8TX rank 3 codebook for 8TX UE with four coherent antenna groups, which includes 8TX rank 3 precoding matrices (W³), each of which is constructed using one 4TX rank 1 partial coherent precoding matrix and one 4TX rank 2 partial coherent precoding matrix.

For rank 3 with three layers (e.g., a first layer, a second layer and a third layer), the first layer may be transmitted by the first antenna group pair (e.g., including PG₀ and PG₁), and each of the second layer and the third layer may be transmitted by the second antenna group pair (e.g., including PG₂ and PG₃), which is referred to as “1+2”. The 8×3 precoding matrix takes the form

$${W}^{3} = \frac{1}{\sqrt{2}} [ \begin{matrix}{W}_{01} & 0 \\ 0 & {W}_{23}\end{matrix} ] ,$$

where W₀₁ ∈

$${W}_{01} ∈ {G}_{2}^{1} , and {W}_{23} ∈ {G}_{2}^{2} .$$

So, the 8TX rank 3 codebook includes a total of

$$\vert {W}^{3} \vert = \vert {G}_{2}^{1} \vert \vert {G}_{2}^{2} \vert = 8 * 8 = 64$$

8TX rank 3 precoding matrices. As a result, the first layer is transmitted by one of antenna groups PG₀ and PG₁ of the first antenna group pair, the second layer is transmitted by one of antenna groups PG₂ and PG₃ of the second antenna group pair; and the third layer is transmitted by the other of antenna groups PG₂ and PG₃ of the second antenna group pair.

Joint TPMI indication or separate TPMI indication can be used to indicate a 8TX rank 3 precoding matrix from W³ for 8TX UE with four coherent antenna groups.

If a 8TX rank 3 precoding matrix is indicated from W³ by a joint TPMI indication, each state represents a combination of (W₀₁, W₂₃). It requires ┌log₂(64)┐(=6) bits to indicate one of 64 precoding matrices.

If a 8TX rank 3 precoding matrix is indicated from W³ by a separate TPMI indication, W₀₁ and W₂₃ are separately indicated. It requires ┌log₂(8)┐(=3) bits to indicate one of 8 precoding matrices from

$${G}_{2}^{1}$$

for W₀₁, and it requires ┌log₂(8)┐(=3) bits to indicate one of 8 precoding matrices from

$${G}_{2}^{2}$$

for W₂₃. That is, a total of 6 bits are necessary for separate TPMI indication.

It is possible to reduce the size of the 8TX rank 3 codebook by only allowing certain combinations of (W₀₁, W₂₃) to obtain a reduced codebook W^{3R}. For example, it is required that the non-zero elements in the columns of W₀₁ and W₂₃ are different. For example, the combination of (W₀₁, W₂₃) such as

$$( \frac{1}{2} [ \begin{matrix}1 \\ 0 \\ 1 \\ 0\end{matrix} ] , \frac{1}{2} [ \begin{matrix}1 & 0 \\ 0 & 1 \\ 1 & 0 \\ 0 & - j\end{matrix} ] ) ,$$

which corresponds to

$${W}^{3} = \frac{1}{2} [ \begin{matrix}1 & 0 & 0 \\ 0 & 0 & 0 \\ 1 & 0 & 0 \\ 0 & 0 & 0 \\ 0 & 1 & 0 \\ 0 & 0 & 1 \\ 0 & 1 & 0 \\ 0 & 0 & - j\end{matrix} ] or$$

$$( \frac{1}{2} [ \begin{matrix}0 \\ 1 \\ 0 \\ 1\end{matrix} ] , \frac{1}{2} [ \begin{matrix}1 & 0 \\ 0 & 1 \\ 1 & 0 \\ 0 & - j\end{matrix} ] ) ,$$

which corresponds to

$${W}^{3} = \frac{1}{2} [ \begin{matrix}0 & 0 & 0 \\ 1 & 0 & 0 \\ 0 & 0 & 0 \\ 1 & 0 & 0 \\ 0 & 1 & 0 \\ 0 & 0 & 1 \\ 0 & 1 & 0 \\ 0 & 0 & - j\end{matrix} ]$$

is not allowed, since the non-zero elements in a column, i.e.,

$$\frac{1}{2} [ \begin{matrix}1 \\ 1\end{matrix} ]$$

appears both in W₀₁ and W₂₃ (which implies that 2-port rank 1 precoding matrix (precoding vector)

$$( \frac{1}{2} [ \begin{matrix}1 \\ 1\end{matrix} ] )$$

is used in group PG₀(or PG₁) and PG₂ to transmit different layers). Although these antenna groups (PG₀ and PG₂ or PG₁ and PG₂) are non-coherent, they may still cause interference to each other because of similar channel condition. So, such combinations are preferably avoided. In other words, only the precoding matrices without two antenna ports using the same 2-port rank 1 precoding matrix (precoding vector) are allowed (i.e., no two layers can share the same 2-port rank 1 precoding matrix (precoding vector)).

In particular, to meet the above-described requirement, only the following (W₀₁, W₂₃) combinations are allowed for W^{3R}:

TABLE 3

| W₀₁ | W₂₃ |
|---|---|
| $\frac{1}{2} [ \begin{matrix}1 \\ 0 \\ - 1 \\ 0\end{matrix} ] , \frac{1}{2} [ \begin{matrix}1 \\ 0 \\ j \\ 0\end{matrix} ] , \frac{1}{2} [ \begin{matrix}0 \\ 1 \\ 0 \\ - 1\end{matrix} ] or \frac{1}{2} [ \begin{matrix}0 \\ 1 \\ 0 \\ j\end{matrix} ]$ | $\frac{1}{2} [ \begin{matrix}1 & 0 \\ 0 & 1 \\ 1 & 0 \\ 0 & - j\end{matrix} ]$ |
| $\frac{1}{2} [ \begin{matrix}1 \\ 0 \\ - 1 \\ 0\end{matrix} ] , \frac{1}{2} [ \begin{matrix}1 \\ 0 \\ - j \\ 0\end{matrix} ] , \frac{1}{2} [ \begin{matrix}0 \\ 1 \\ 0 \\ - 1\end{matrix} ] or \frac{1}{2} [ \begin{matrix}0 \\ 1 \\ 0 \\ - j\end{matrix} ]$ | $\frac{1}{2} [ \begin{matrix}1 & 0 \\ 0 & 1 \\ 1 & 0 \\ 0 & j\end{matrix} ]$ |
| $\frac{1}{2} [ \begin{matrix}1 \\ 0 \\ - 1 \\ 0\end{matrix} ] , \frac{1}{2} [ \begin{matrix}1 \\ 0 \\ j \\ 0\end{matrix} ] , \frac{1}{2} [ \begin{matrix}0 \\ 1 \\ 0 \\ - 1\end{matrix} ] or \frac{1}{2} [ \begin{matrix}0 \\ 1 \\ 0 \\ j\end{matrix} ]$ | $\frac{1}{2} [ \begin{matrix}1 & 0 \\ 0 & 1 \\ - j & 0 \\ 0 & 1\end{matrix} ]$ |
| $\frac{1}{2} [ \begin{matrix}1 \\ 0 \\ 1 \\ 0\end{matrix} ] , \frac{1}{2} [ \begin{matrix}1 \\ 0 \\ j \\ 0\end{matrix} ] , \frac{1}{2} [ \begin{matrix}0 \\ 1 \\ 0 \\ 1\end{matrix} ] , or \frac{1}{2} [ \begin{matrix}0 \\ 1 \\ 0 \\ j\end{matrix} ]$ | $\frac{1}{2} [ \begin{matrix}1 & 0 \\ 0 & 1 \\ - j & 0 \\ 0 & - 1\end{matrix} ]$ |
| $\frac{1}{2} [ \begin{matrix}1 \\ 0 \\ 1 \\ 0\end{matrix} ] , \frac{1}{2} [ \begin{matrix}1 \\ 0 \\ j \\ 0\end{matrix} ] , \frac{1}{2} [ \begin{matrix}0 \\ 1 \\ 0 \\ 1\end{matrix} ] , or \frac{1}{2} [ \begin{matrix}0 \\ 1 \\ 0 \\ j\end{matrix} ]$ | $\frac{1}{2} [ \begin{matrix}1 & 0 \\ 0 & 1 \\ - 1 & 0 \\ 0 & - j\end{matrix} ]$ |
| $\frac{1}{2} [ \begin{matrix}1 \\ 0 \\ 1 \\ 0\end{matrix} ] , \frac{1}{2} [ \begin{matrix}1 \\ 0 \\ - j \\ 0\end{matrix} ] , \frac{1}{2} [ \begin{matrix}0 \\ 1 \\ 0 \\ 1\end{matrix} ] or \frac{1}{2} [ \begin{matrix}0 \\ 1 \\ 0 \\ - j\end{matrix} ]$ | $\frac{1}{2} [ \begin{matrix}1 & 0 \\ 0 & 1 \\ - 1 & 0 \\ 0 & j\end{matrix} ]$ |
| $\frac{1}{2} [ \begin{matrix}1 \\ 0 \\ - 1 \\ 0\end{matrix} ] , \frac{1}{2} [ \begin{matrix}1 \\ 0 \\ - j \\ 0\end{matrix} ] , \frac{1}{2} [ \begin{matrix}0 \\ 1 \\ 0 \\ - 1\end{matrix} ] or \frac{1}{2} [ \begin{matrix}0 \\ 1 \\ 0 \\ - j\end{matrix} ]$ | $\frac{1}{2} [ \begin{matrix}1 & 0 \\ 0 & 1 \\ j & 0 \\ 0 & 1\end{matrix} ]$ |
| $\frac{1}{2} [ \begin{matrix}1 \\ 0 \\ 1 \\ 0\end{matrix} ] , \frac{1}{2} [ \begin{matrix}1 \\ 0 \\ - j \\ 0\end{matrix} ] , \frac{1}{2} [ \begin{matrix}0 \\ 1 \\ 0 \\ 1\end{matrix} ] or \frac{1}{2} [ \begin{matrix}0 \\ 1 \\ 0 \\ - j\end{matrix} ]$ | $\frac{1}{2} [ \begin{matrix}1 & 0 \\ 0 & 1 \\ j & 0 \\ 0 & - 1\end{matrix} ]$ |

It can be seen from Table 3 that for each of 8 4TX rank 2 partial coherent precoding matrices from

$${G}_{2}^{2}$$

for W₂₃, only a reduced number (i.e., 4) 4TX rank 1 partial coherent precoding matrices can be selected from

$${G}_{2}^{1}$$

for W₀₁. That is, for each of 8 4TX rank 2 partial coherent precoding matrices from

$${G}_{2}^{2}$$

selected for W₂₃, there are only 4 valid 4TX rank 1 partial coherent precoding matrices can be selected from

$${G}_{2}^{1}$$

for W₀₁. Accordingly, only 32=8×4 combinations of (W₀₁, W₂₃) are allowed for W^{3R}, which implies that W^{3R} includes 32 8TX rank 3 precoding matrices.

Joint TPMI indication or separate TPMI indication can be used to indicate a 8TX rank 3 precoding matrix from W^{3R}.

If a 8TX rank 3 precoding matrix is indicated from W^{3R} by a joint TPMI indication, each state represents a combination of (W₀₁, W₂₃). It requires ┌log₂(32)┐(=5) bits to indicate one of 64 precoding matrices.

If a 8TX rank 3 precoding matrix is indicated from W^{3R} by a separate TPMI indication, W₀₁ and W₂₃ are separately indicated. It requires ┌log₂(8)┐(=3) bits to indicate one of 8 precoding matrices from

$${G}_{2}^{2}$$

for W₂₃, and for the indicated W₂₃, it requires ┌log₂(4)┐(=2) bits to indicate one of 4 valid precoding matrices from

$${G}_{2}^{1}$$

for W₀₁. That is, a total of 5 bits are necessary for separate TPMI indication.

For rank 3 with three layers (e.g., a first layer, a second layer and a third layer), if “2+1” (i.e., the first layer and the second layer are transmitted by the first antenna group pair (e.g., including PG₀ and PG₁), and the third layer is transmitted by the second antenna group pair (e.g., including PG₂ and PG₃)) is supported in addition to “1+2”, an extra bit is necessary to distinguish between “1+2” and “2+1”.

A fourth sub-embodiment of the second embodiment relates to 8TX rank 4 codebook for 8TX UE with four coherent antenna groups, which includes 8TX rank 4 precoding matrices (W⁴), each of which is constructed using two 4TX rank 2 partial coherent precoding matrices.

For rank 4 with four layers (e.g., a first layer, a second layer, a third layer and a fourth layer), the first layer and the second layer may be transmitted by the first antenna group pair (e.g., including PG_{O} and PG₁), and the third layer and the fourth layer may be transmitted by the second antenna group pair (e.g., including PG₂ and PG₃), which is referred to as “2+2”. The 8×4 precoding matrix takes the form

$${W}^{4} = \frac{1}{\sqrt{2}} [ \begin{matrix}{W}_{01} & 0 \\ 0 & {W}_{23}\end{matrix} ] ,$$

where W₀₁ ∈

$${G}_{2}^{2} ,$$

### and W₂₃ ∈

$${G}_{2}^{2} .$$

So, the 8TX rank 4 codebook includes a total of

$$\vert {W}^{4} \vert = \vert {G}_{2}^{2} \vert \vert {G}_{2}^{2} \vert = 8 * 8 = 64$$

8TX rank 4 precoding matrices. As a result, each layer is transmitted by a separate antenna group. For example, the first layer is transmitted by one of antenna groups PG₀ and PG₁ of the first antenna group pair, the second layer is transmitted by the other of antenna groups PG₀ and PG₁ of the first antenna group pair, the third layer is transmitted by one of antenna groups PG₂ and PG₃ of the second antenna group pair; and the fourth layer is transmitted by the other of antenna groups PG₂ and PG₃ of the second antenna group pair.

Joint TPMI indication or separate TPMI indication can be used to indicate a 8TX rank 4 precoding matrix from W⁴ for 8TX UE with four coherent antenna groups.

If a 8TX rank 4 precoding matrix is indicated from W⁴ by a joint TPMI indication, each state represents a combination of (W₀₁, W₂₃). It requires ┌log₂(64)┐(=6) bits to indicate one of 64 precoding matrices.

If a 8TX rank 4 precoding matrix is indicated from W⁴ by a separate TPMI indication, W₀₁ and W₂₃ are separately indicated. It requires ┌log₂(8)┐(=3) bits to indicate one of 8 precoding matrices from

$${G}_{2}^{2}$$

for W₀₁, and it requires ┌log₂(8)┐(=3) bits to indicate one of 8 precoding matrices fron Gz for W₂₃. That is, a total of 6 bits are necessary for separate TPMI indication.

$${G}_{2}^{2}$$

It is possible to reduce the size of the 8TX rank 4 codebook by only allowing certain combinations of (W₀₁, W₂₃) to obtain a reduced codebook W^{4R}. For example, only the precoding matrices without two antenna ports using the same 2-port rank 1 precoding matrix (precoding vector) are allowed (i.e., no two layers can share the same 2-port rank 1 precoding matrix (precoding vector)) in the reduced codebook W^{4R}. For example, (W₀₁, W₂₃) like

$$( \frac{1}{2} [ \begin{matrix}1 & 0 \\ 0 & 1 \\ 1 & 0 \\ 0 & - j\end{matrix} ] , \frac{1}{2} [ \begin{matrix}1 & 0 \\ 0 & 1 \\ j & 0 \\ 0 & 1\end{matrix} ] )$$

is not allowed, since the 2-port rank 1 precoding matrix (precoding vector)

$$\frac{1}{2} [ \begin{matrix}1 \\ 1\end{matrix} ]$$

appears in both W₀₁ and W₂₃, i.e., is used in both PG₀ (in the first antenna group pair) and PG₃ (in the second antenna group pair).

In particular, to meet the above-described requirement, only the following (W₀₁, W₂₃) combinations are allowed for W^{4R}:

TABLE 4

| W₀₁ | W₂₃ |
|---|---|
| $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ] , or \frac{1}{2} [ \begin{matrix}1 & 0 \\ 0 & 1 \\ j & 0 \\ 0 & - 1\end{matrix} ]$ |
| $\frac{1}{2} [ \begin{matrix}1 & 0 \\ 0 & 1 \\ 1 & 0 \\ 0 & j\end{matrix} ]$ | $\frac{1}{2} [ \begin{matrix}1 & 0 \\ 0 & 1 \\ - j & 0 \\ 0 & - 1\end{matrix} ] or \frac{1}{2} [ \begin{matrix}1 & 0 \\ 0 & 1 \\ - 1 & 0 \\ 0 & - j\end{matrix} ]$ |
| $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - 1 & 0 \\ 0 & j\end{matrix} ] or \frac{1}{2} [ \begin{matrix}1 & 0 \\ 0 & 1 \\ j & 0 \\ 0 & - 1\end{matrix} ]$ |
| $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ 1 & 0 \\ 0 & j\end{matrix} ] or \frac{1}{2} [ \begin{matrix}1 & 0 \\ 0 & 1 \\ j & 0 \\ 0 & 1\end{matrix} ]$ |
| $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ] or \frac{1}{2} [ \begin{matrix}1 & 0 \\ 0 & 1 \\ j & 0 \\ 0 & 1\end{matrix} ]$ |
| $\frac{1}{2} [ \begin{matrix}1 & 0 \\ 0 & 1 \\ - 1 & 0 \\ 0 & j\end{matrix} ]$ | $\frac{1}{2} [ \begin{matrix}1 & 0 \\ 0 & 1 \\ 1 & 0 \\ 0 & - j\end{matrix} ] or \frac{1}{2} [ \begin{matrix}1 & 0 \\ 0 & 1 \\ - j & 0 \\ 0 & 1\end{matrix} ]$ |
| $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ - j & 0 \\ 0 & - 1\end{matrix} ] or \frac{1}{2} [ \begin{matrix}1 & 0 \\ 0 & 1 \\ - 1 & 0 \\ 0 & - j\end{matrix} ]$ |
| $\frac{1}{2} [ \begin{matrix}1 & 0 \\ 0 & 1 \\ j & 0 \\ 0 & - 1\end{matrix} ]$ | $\frac{1}{2} [ \begin{matrix}1 & 0 \\ 0 & 1 \\ 1 & 0 \\ 0 & - j\end{matrix} ] or \frac{1}{2} [ \begin{matrix}1 & 0 \\ 0 & 1 \\ - j & 0 \\ 0 & 1\end{matrix} ]$ |

It can be seen from Table 4 that for each of 8 4TX rank 2 partial coherent precoding matrices from

$${G}_{2}^{2}$$

for W₀₁, only a reduced number (i.e., 2) 4TX rank 2 partial coherent precoding matrices can be selected from

$${G}_{2}^{2}$$

for W₂₃. That is, for each of 8 4TX rank 2 partial coherent precoding matrices from

$${G}_{2}^{2}$$

selected for W₀₁, there are only 2 valid 4TX rank 2 partial coherent precoding matrices can be selected from

$${G}_{2}^{2}$$

for W₂₃. Accordingly, only 16=8×2 combinations of (W₀₁, W₂₃) are allowed for W^{4R}, which implies that W^{4R} includes 16 8TX rank 4 precoding matrices.

Joint TPMI indication or separate TPMI indication can be used to indicate a 8TX rank 4 precoding matrix from W^{4R}.

If a 8TX rank 4 precoding matrix is indicated from W^{4R} by a joint TPMI indication, each state represents a combination of (W₀₁, W₂₃). It requires ┌log₂(16)┐(=4) bits to indicate one of 16 precoding matrices.

If a 8TX rank 4 precoding matrix is indicated from W^{4R} by a separate TPMI indication, W₀₁ and W₂₃ are separately indicated. It requires ┌log₂(8)┐(=3) bits to indicate one of 8 precoding matrices from

$${G}_{2}^{2}$$

for W₀₁, and for the indicated W₀₁, it requires ┌log₂ (2)┐(=1) bits to indicate one of 2 valid precoding matrices from

$${G}_{2}^{2}$$

for W₂₃. That is, a total of 4 bits are necessary for separate TPMI indication.

A fifth sub-embodiment of the second embodiment relates to 8TX rank 5 codebook for 8TX UE with four coherent antenna groups, which includes 8TX rank 5 precoding matrices (W⁵), each of which is constructed using one 4TX rank 2 partial coherent precoding matrix and one 4TX rank 3 partial coherent precoding matrix.

For rank 5 with five layers (e.g., a first layer, a second layer, a third layer, a fourth layer and a fifth layer), the first layer and the second layer may be transmitted by the first antenna group pair (e.g., including PG₀ and PG₁), and the third layer, the fourth layer and the fifth layer may be transmitted by the second antenna group pair (e.g., including PG₂ and PG₃), which is referred to as “2+3”. The 8×5 precoding matrix takes the form

$${W}^{5} = \frac{1}{\sqrt{2}} [ \begin{matrix}{W}_{01} & 0 \\ 0 & {W}_{23}\end{matrix} ] ,$$

where W₀₁ ∈

$${W}_{01} ∈ {G}_{2}^{2} , and {W}_{23} ∈ {G}_{2}^{3} .$$

### and W₂₃ ∈

So, the 8TX rank 5 codebook includes a total of

$$\vert {W}^{5} \vert = \vert {G}_{2}^{2} \vert \vert {G}_{2}^{3} \vert = 8 * 2 = 16$$

8 TX rank 5 precoding matrices. As a result, each layer is transmitted by one antenna port or by two antenna ports in an antenna group.

Joint TPMI indication or separate TPMI indication can be used to indicate a 8TX rank 5 precoding matrix from W⁵ for 8TX UE with four coherent antenna groups.

If a 8TX rank 5 precoding matrix is indicated from W⁵ by a joint TPMI indication, each state represents a combination of (W₀₁, W₂₃). It requires ┌log₂(16)┐(=4) bits to indicate one of 16 precoding matrices.

If a 8TX rank 5 precoding matrix is indicated from W⁵ by a separate TPMI indication, W₀₁ and W₂₃ are separately indicated. It requires ┌log₂(8)┐(=3) bits to indicate one of 8 precoding matrices from

$${G}_{2}^{2}$$

for W₀₁, and it requires ┌log₂(2)┐(=1) bit to indicate one of 2 precoding matrices from

$${G}_{2}^{3}$$

for W₂₃. That is, a total of 4 bits are necessary for separate TPMI indication.

It is possible to reduce the size of the 8TX rank 5 codebook by only allowing certain combinations of (W₀₁, W₂₃) to obtain a reduced codebook W^{5R}. For example, only the precoding matrices without two antenna ports using the same 2-port rank 1 precoding matrix (precoding vector) are allowed (i.e., no two layers can share the same 2-port rank 1 precoding matrix (precoding vector)) in the reduced codebook W^{5R}. For example, (W₀₁, W₂₃) like

$$( \frac{1}{2} [ \begin{matrix}1 & 0 \\ 0 & 1 \\ - j & 0 \\ 0 & 1\end{matrix} ] , \frac{1}{2} [ \begin{matrix}1 & 0 & 0 \\ 0 & 1 & 0 \\ 1 & 0 & 0 \\ 0 & 0 & 1\end{matrix} ] )$$

is not allowed, since the 2-port rank 1 precoding matrix (precoding vector)

$$\frac{1}{2} [ \begin{matrix}1 \\ 1\end{matrix} ]$$

appears in both on W₀₁ and W₂₃, i.e., is used in both PG₁ (in the first antenna group pair) or the second ayer and PG₂ (in the second antenna group pair) or the third layer.

In particular, to meet the above-described requirement, only the following (W₀₁, W₂₃) combinations are allowed for W^{5R}:

TABLE 5

| W₀₁ | W₂₃ |
|---|---|
| $\frac{1}{2} [ \begin{matrix}1 & 0 \\ 0 & 1 \\ - j & 0 \\ 0 & - 1\end{matrix} ] , \frac{1}{2} [ \begin{matrix}1 & 0 \\ 0 & 1 \\ - 1 & 0 \\ 0 & - j\end{matrix} ] , \frac{1}{2} [ \begin{matrix}1 & 0 \\ 0 & 1 \\ - 1 & 0 \\ 0 & j\end{matrix} ] , or \frac{1}{2} [ \begin{matrix}1 & 0 \\ 0 & 1 \\ j & 0 \\ 0 & - 1\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ |
| $\frac{1}{2} [ \begin{matrix}1 & 0 \\ 0 & 1 \\ 1 & 0 \\ 0 & - j\end{matrix} ] , \frac{1}{2} [ \begin{matrix}1 & 0 \\ 0 & 1 \\ 1 & 0 \\ 0 & j\end{matrix} ] , \frac{1}{2} [ \begin{matrix}1 & 0 \\ 0 & 1 \\ - j & 0 \\ 0 & 1\end{matrix} ] or \frac{1}{2} [ \begin{matrix}1 & 0 \\ 0 & 1 \\ j & 0 \\ 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ |

It can be seen from Table 5 that for each of 2 4TX rank 3 partial coherent precoding matrices from

$${G}_{2}^{3}$$

for W₂₃, only a reduced number (i.e., 4) 4TX rank 2 partial coherent precoding matrices can be selected from

$${G}_{2}^{2}$$

for W₀₁. That is, for each of 2 4TX rank 3 partial coherent precoding matrices from

$${G}_{2}^{3}$$

selected for W₂₃, there are only 4 valid 4TX rank 2 partial coherent precoding matrices can be selected from

$${G}_{2}^{2}$$

for W₀₁. Accordingly, only 8=4×2 combinations of (W₀₁, W₂₃) are allowed for W^{5R}, which implies that W^{5R} includes 8 8TX rank 5 precoding matrices.

Joint TPMI indication or separate TPMI indication can be used to indicate a 8TX rank 5 precoding matrix from W^{5R}.

If a 8TX rank 5 precoding matrix is indicated from W^{5R} by a joint TPMI indication, each state represents a combination of (W₀₁, W₂₃). It requires ┌log₂(8)┐(=3) bits to indicate one of 8 precoding matrices.

If a 8TX rank 5 precoding matrix is indicated from W^{5R} by a separate TPMI indication, W₀₁ and W₂₃ are separately indicated. It requires ┌log₂(2)┐(=1) bit to indicate one of 2 precoding igge from

$${G}_{2}^{3}$$

for W₂₃, and for the indicated W₂₃, it requires ┌log₂(4)┐(=2) bits to indicate one of 4 valid precoding matrices from

$${G}_{2}^{2}$$

for W₀₁. That is, a total of 3 bits are necessary for separate TPMI indication.

For rank 5 with five layers (e.g., a first layer, a second layer, a third layer, a fourth layer and a fifth layer), if “3+2” (i.e., the first layer, the second layer and the third layer are transmitted by the first antenna group pair (e.g., including PG₀ and PG₁), and the fourth layer and the fifth layer are transmitted by the second antenna group pair (e.g., including PG₂ and PG₃)) is supported in addition to “2+3”, an extra bit is necessary to distinguish between “2+3” and “3+2”.

In addition, W^{5R} for “3+2” will be as follows:

TABLE 6

| W₀₁ | W₂₃ |
|---|---|
| $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 \\ 0 & 1 \\ - j & 0 \\ 0 & - 1\end{matrix} ] , \frac{1}{2} [ \begin{matrix}1 & 0 \\ 0 & 1 \\ - 1 & 0 \\ 0 & - j\end{matrix} ] , \frac{1}{2} [ \begin{matrix}1 & 0 \\ 0 & 1 \\ - 1 & 0 \\ 0 & j\end{matrix} ] , or \frac{1}{2} [ \begin{matrix}1 & 0 \\ 0 & 1 \\ j & 0 \\ 0 & - 1\end{matrix} ]$ |
| $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2} [ \begin{matrix}1 & 0 \\ 0 & 1 \\ 1 & 0 \\ 0 & - j\end{matrix} ] , \frac{1}{2} [ \begin{matrix}1 & 0 \\ 0 & 1 \\ 1 & 0 \\ 0 & j\end{matrix} ] , \frac{1}{2} [ \begin{matrix}1 & 0 \\ 0 & 1 \\ - j & 0 \\ 0 & 1\end{matrix} ] or \frac{1}{2} [ \begin{matrix}1 & 0 \\ 0 & 1 \\ j & 0 \\ 0 & 1\end{matrix} ]$ |

That is, if the extra bit indicates “3+2”, joint TPMI indication or separate TPMI indication can be used to indicate a 8TX rank 5 precoding matrix from W^{5R} for “3+2”.

If a 8TX rank 5 precoding matrix is indicated from W^{5R} for “3+2” by a joint TPMI indication, each state represents a combination of (W₀₁, W₂₃). It requires ┌log₂(8)┐(=3) bits to indicate one of 8 precoding matrices for the joint TPMI indication in addition to the extra bit.

If a 8TX rank 5 precoding matrix is indicated from W^{5R} for “3+2” by a separate TPMI indication, W₀₁ and W₂₃ are separately indicated. It requires ┌log₂ (2)┐(=1) bit to indicate one of 2 precoding matrices from

$${G}_{2}^{3}$$

for W and for the selected W₀₁, it requires ┌log₂(4)┐(=2) bits to indicate one of 4 valid precoding matrices from

$${G}_{2}^{2}$$

for W₂₃. That is, a total of 3 bits are necessary for separate TPMI indication in addition to the extra bit.

A sixth sub-embodiment of the second embodiment relates to 8TX rank 6 codebook for 8TX UE with four coherent antenna groups, which includes 8TX rank 6 precoding matrice (W⁶), each of which is constructed using two 4TX rank 3 partial coherent precoding matrices.

For rank 6 with sixth layers (e.g., a first layer, a second layer, a third layer, a fourth layer, a fifth layer and a sixth layer), the first layer, the second layer and the third layer may be transmitted by the first antenna group pair (e.g., including PG₀ and PG₁), and the fourth layer, the fifth layer and the sixth layer may be transmitted by the second antenna group pair (e.g., including PG₂ and PG₃), which is referred to as “3+3”. The 8×6 precoding matrix takes the form

$${W}^{6} = \frac{1}{\sqrt{2}} [ \begin{matrix}{W}_{01} & 0 \\ 0 & {W}_{23}\end{matrix} ] ,$$

where

$${W}_{01} ∈ {G}_{2}^{3} , and {W}_{23} ∈ {G}_{2}^{3} .$$

So, the 8TX rank 6 codebook includes a total of

$$\vert {W}^{6} \vert = \vert {G}_{2}^{3} \vert \vert {G}_{2}^{3} \vert = 2 * 2 = 4$$

precoding matrices. As a result, each layer is transmitted by one antenna port or by two antenna ports in an antenna group.

Joint TPMI indication or separate TPMI indication can be used to indicate a 8TX rank 6 precoding matrix from W⁶ for 8TX UE with four coherent antenna groups.

If a 8TX rank 6 precoding matrix is indicated from W⁶ by a joint TPMI indication, each state represents a combination of (W₀₁, W₂₃). It requires ┌log₂(4)┐(=2) bits to indicate one of 4 precoding matrices.

If a 8TX rank 6 precoding matrix is indicated from W⁶ by a separate TPMI indication, W₀₁ and W₂₃ are separately indicated. It requires ┌log₂(2)┐(=1) bit to indicate one of 2 precoding matrices from

$${G}_{2}^{3}$$

for W₀₁, and it requires ┌log₂ (2)┐(=1) bit to indicate one of 2 precoding matrices from

$${G}_{2}^{3}$$

for W₂₃. That is, a total of 2 bits are necessary for separate TPMI indication.

A seventh sub-embodiment of the second embodiment relates to 8TX rank 7 codebook for 8TX UE with four coherent antenna groups, which includes 8TX rank 7 precoding matrices (W⁷), each of which is constructed using one 4TX rank 3 partial coherent precoding matrix and one 4TX rank 4 partial coherent precoding matrix.

For rank 7 with seven layers (e.g., a first layer, a second layer, a third layer, a fourth layer, a fifth layer, a sixth layer and a seventh layer), the first layer, the second layer and the third layer may be transmitted by the first antenna group pair (e.g., including PG₀ and PG₁), and the fourth layer, the fifth layer, the sixth layer and the seventh layer may be transmitted by the second antenna group pair (e.g., including PG₂ and PG₃), which is referred to as “3+4”. The 8×7 precoding matrix takes the form

$${W}^{7} = \frac{1}{\sqrt{2}} [ \begin{matrix}{W}_{01} & 0 \\ 0 & {W}_{23}\end{matrix} ] ,$$

where W₀₁ ∈

$${G}_{2}^{3} ,$$

### and W₂₃ ∈

$${G}_{2}^{4} .$$

So, the 8TX rank 7 codebook includes a total of

$$\vert {W}^{7} \vert = \vert {G}_{2}^{3} \vert \vert {G}_{2}^{4} \vert = 2 * 2 = 4$$

8TX rank 7 precoding matrices. As a result, each layer is transmitted by one antenna port or by two antenna ports in an antenna group.

Joint TPMI indication or separate TPMI indication can be used to indicate a 8TX rank 7 precoding matrix from W⁷ for 8TX UE with four coherent antenna groups.

If a 8TX rank 7 precoding matrix is indicated from W⁷ by a joint TPMI indication, each state represents a combination of (W₀₁, W₂₃). It requires ┌log₂(4)┐(=2) bits to indicate one of 4 precoding matrices.

If a 8TX rank 7 precoding matrix is indicated from W⁷ by a separate TPMI indication, W₀₁ and W₂₃ are separately indicated. It requires ┌log₂(2)┐(=1) bit to indicate one of 2 precoding matrices from

$${G}_{2}^{3}$$

for W₀₁, and it requires ┌log₂(2)┐(=1) bit to indicate one of 2 precoding matrices from

$${G}_{2}^{4}$$

for W₂₃. That is, a total of 2 bits are necessary for separate TPMI indication.

It is possible to reduce the size of the 8TX rank 7 codebook by only allowing certain combinations of (W₀₁, W₂₃) to obtain a reduced codebook W^{7R}. For example, only the precoding matrices without two antenna ports using the same 2-port rank 1 precoding matrix (precoding vector) are allowed (i.e., no two layers can share the same 2-port rank 1 precoding matrix (precoding vector)) in the reduced codebook W^{7R}. That is, only the following (W₀₁, W₂₃) combinations are allowed for W^{7R}:

TABLE 7

| W₀₁ | W₂₃ |
|---|---|
| $\frac{1}{2} [ \begin{matrix}1 & 0 & 0 \\ 0 & 1 & 0 \\ 1 & 0 & 0 \\ 0 & 0 & 1\end{matrix} ] or \frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ |

It can be seen from Table 7 that for each of 2 4TX rank 3 partial coherent precoding matrices from

$${G}_{2}^{3}$$

for W₀₁, only a reduced number (i.e., 1) 4TX rank 4 partial coherent precoding matrices can be selected from

$${G}_{2}^{4}$$

for W₂₃. That is, for each of 2 4TX rank 3 partial coherent precoding matrices from

$${G}_{2}^{3}$$

selected for W₀₁, there is only 1 valid 4TX rank 4 partial coherent precoding matrices can be selected from

$${G}_{2}^{4}$$

for W₂₃. Accordingly, only 2=1×2 combinations of (W₀₁, W₂₃) are allowed for W^{7R}, which implies that W^{7R} includes 2 8TX rank 7 precoding matrices.

It requires ┌log₂(2)┐(=1) bit to indicate one of 2 precoding matrices from W^{7R}.

An eighth sub-embodiment of the second embodiment relates to 8TX rank 8 codebook for 8TX UE with four coherent antenna groups, which includes 8TX rank 8 precoding matrice (W⁸), each of which is constructed using two 4TX rank 4 partial coherent precoding matrices.

For rank 8 with eight layers (e.g., a first layer, a second layer, a third layer, a fourth layer, a fifth layer, a sixth layer, a seventh layer and an eighth layer), the first layer, the second layer, the third layer and the fourth layer may be transmitted by the first antenna group pair (e.g., including PG₀ and PG₁), and the fifth layer, the sixth layer, the seventh layer and the eighth layer may be transmitted by the second antenna group pair (e.g., including PG₂ and PG₃), which is referred to as “4+4”. The 8×8 precoding matrix takes the form

$${W}^{8} = \frac{1}{\sqrt{2}} [ \begin{matrix}{W}_{01} & 0 \\ 0 & {W}_{23}\end{matrix} ] ,$$

where

$${W}_{01} ∈ {G}_{2}^{4} , and {W}_{23} ∈ {G}_{2}^{4} .$$

So, the 8TX rank 8 codebook includes a total of

$$\vert {W}^{8} \vert = \vert {G}_{2}^{4} \vert \vert {G}_{2}^{4} \vert = 2 * 2 = 4$$

precoding matrices. As a result, each layer is transmitted by two antenna ports in an antenna group.

Joint TPMI indication or separate TPMI indication can be used to indicate a 8TX rank 8 precoding matrix from W⁸ for 8TX UE with four coherent antenna groups.

If a 8TX rank 8 precoding matrix is indicated from W⁸ by a joint TPMI indication, each state represents a combination of (W₀₁, W₂₃). It requires ┌log₂(4)┐(=2) bits to indicate one of 4 precoding matrices.

If a 8TX rank 8 precoding matrix is indicated from W^{s} by a separate TPMI indication, W₀₁ and W₂₃ are separately indicated. It requires ┌log₂(2)┐(=1) bit to indicate one of 2 precoding matrices from

$${G}_{2}^{4}$$

for W₀₁, and it requires ┌log₂(2)┐(=1) bit to indicate one of 2 precoding matrices from

$${G}_{2}^{4}$$

for W₂₃. That is, a total of 2 bits are necessary for separate TPMI indication.

It is possible to reduce the size of the 8TX rank 6 codebook by only allowing certain combinations of (W₀₁, W₂₃) to obtain a reduced codebook W^{8R}. For example, only the precoding matrices without two antenna ports using the same 2-port rank 1 precoding matrix (precoding vector) are allowed (i.e., no two layers can share the same 2-port rank 1 precoding matrix (precoding vector)) in the reduced codebook W^{8R}. That is, only the following (Wo₁, W₂₃) combinations are allowed for W^{8R}:

TABLE 8

| W₀₁ | W₂₃ |
|---|---|
| $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ |
| $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ |

It can be seen from Table 8 that for each of 2 4TX rank 4 partial coherent precoding matrices from

$${G}_{2}^{4}$$

for W₀₁, only a reduced number (i.e., 1) 4TX rank 4 partial coherent precoding matrices can be selected from

$${G}_{2}^{4}$$

for W₂₃. That is, for each of 2 4TX rank 4 partial coherent precoding matrices from

$${G}_{2}^{4}$$

selected for W₀₁, there is only 1 valid 4TX rank 4 partial coherent precoding matrices can be selected from

$${G}_{2}^{4}$$

for W₂₃. Accordingly, only 2=1×2 combinations of (W₀₁, W₂₃) are allowed for W^{8R}, which implies that W^{7R} includes 2 8TX rank 8 precoding matrices

It requires ┌log₂(2)┐(=1) bit to indicate one of 2 precoding matrices from W^{8R}.

Further, it is possible that only

$$( {W}_{01 ,} {W}_{23} ) = ( \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] , \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] )$$

is allowed, or only

$$( {W}_{01 ,} {W}_{23} ) = ( \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] , \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] )$$

is allowed. In this condition, since there is only one possible combination of (W₀₁, W₂₃), it is indicated by default.

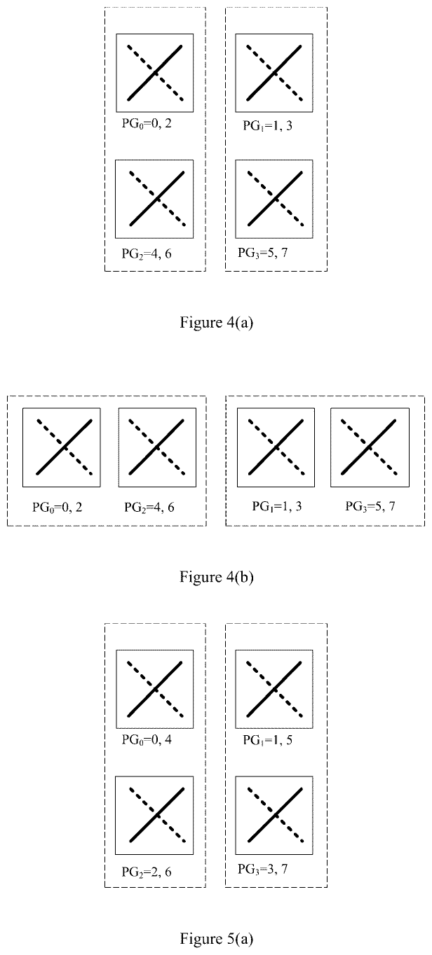

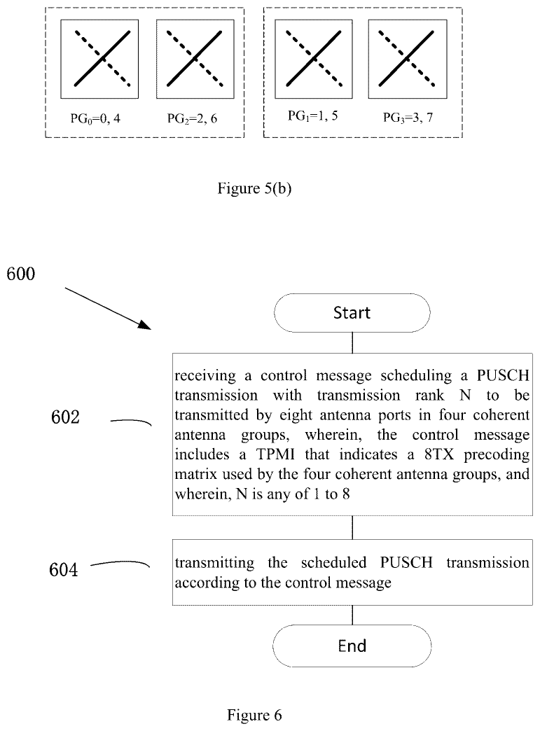

The above-described first to eighth sub-embodiments of the second embodiment are described by taking the antenna ports numbering shown in FIGS. 2(a) and 2(b) into consideration. The above-described first to eighth sub-embodiments of the second embodiment also apply to other antenna ports numberings, such as those shown in FIGS. 3(a) and 3(b), FIGS. 4(a) and 4(b), or FIGS. 5(a) and 5(b), etc.

FIGS. 3(a) and 3(b) illustrate a second antenna ports numbering. PG₀ includes antenna ports 0 and 4, PG₁ includes antenna ports 1 and 5, PG₂ includes antenna ports 2 and 6, and PG₃ includes antenna ports 3 and 7. In addition, PG₀ and PG₁ are grouped together as the first antenna group pair; and PG₂ and PG₃ are grouped together as a second antenna group pair. It can be seen that the second antenna ports numbering differs from the first antenna ports numbering (i.e., the antenna ports numbering shown in FIGS. 2(a) and 2(b)) in that the antenna ports included in each antenna group are different, while the antenna groups in each antenna group pair are the same.

FIGS. 4(a) and 4(b) illustrate a third antenna ports numbering. PG₀ includes antenna ports 0 and 2, PG₁ includes antenna ports 1 and 3, PG₂ includes antenna ports 4 and 6, and PG₃ includes antenna ports 5 and 7. In addition, PG₀ and PG₂ are grouped together as the first antenna group pair; and PGᵢ and PG₃ are grouped together as the second antenna group pair.

It can be seen that the third antenna ports numbering differs from the first antenna ports numbering in that the antenna groups in each antenna group pair are different, while the antenna ports included in each antenna group are the same.

FIGS. 5(a) and 5(b) illustrate a fourth antenna ports numbering. PG₀ includes antenna ports 0 and 4, PG₁ includes antenna ports 1 and 5, PG₂ includes antenna ports 2 and 6, and PG₃ includes antenna ports 3 and 7. In addition, PG₀ and PG₂ are grouped together as the first antenna group pair; and PG_{I} and PG₃ are grouped together as the second antenna group pair. It can be seen that the fourth antenna ports numbering differs from the first antenna ports numbering in that the antenna groups in each antenna group pair are different and that the antenna ports included in each antenna group are different.

The antenna port numbers in FIG. 3(a) or 3(b) (and in FIG. 4(a) or 4(b), and in FIG. 5(a) or 5(b)) are equivalent to changing the sequence of antenna ports 0, 1, 2, 3, 4, 5, 6, 7 of FIG. 2(a) or 2(b) to a sequence of antenna ports 0, 1, 4, 5, 2, 3, 6, 7 (for FIG. 3(a) or 3(b)), a sequence of antenna ports 0, 4, 2, 6, 1, 5, 3, 7 (for FIG. 4(a) or 4(b)), and a sequence of antenna ports 0, 2, 4, 6, 1, 3, 5, 7 (for FIG. 5(a) or 5(b)), as in Table 9.

TABLE 9

| | | | | | | | | |
|---|---|---|---|---|---|---|---|---|
| FIG. 2(a) or 2(b) | 0 | 1 | 2 | 3 | 4 | 5 | 6 | 7 |
| FIG. 3(a) or 3(b) | 0 | 1 | 4 | 5 | 2 | 3 | 6 | 7 |
| FIG. 4(a) or 4(b) | 0 | 4 | 2 | 6 | 1 | 5 | 3 | 7 |
| FIG. 5(a) or 5(b) | 0 | 2 | 4 | 6 | 1 | 3 | 5 | 7 |

Each of the 8 antenna port corresponds to one row of 8TX rank N (N is from 1 to 8) precoding matrix. When the sequence of antenna ports 0, 1, 2, 3, 4, 5, 6, 7 changes to the sequence of antenna ports 0, 1, 4, 5, 2, 3, 6, 7, the corresponding rows of 8TX rank N (N is from 1 to 8) precoding matrix shall be changed with the same manner.

For example, if a rank 6 precoding matrix for the antenna ports numbering shown in FIGS. 2(a) and 2(b) is

$${W}^{6} = \frac{1}{2 \sqrt{2}} [ \begin{matrix}1 & 0 & 0 & 0 & 0 & 0 \\ 0 & 1 & 0 & 0 & 0 & 0 \\ 1 & 0 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & - 1 & 0 & 0 \\ 0 & 0 & 0 & 0 & 0 & 1\end{matrix} ] ,$$

when row 2 and row 4 are swapped and row 3 and row 5 are swapped, the rank 6 precoding matrix for the second antenna ports numbering shown in FIGS. 3(a) and 3(b) can be constructed as

$${W}^{6 ′} = \frac{1}{2 \sqrt{2}} [ \begin{matrix}1 & 0 & 0 & 0 & 0 & 0 \\ 0 & 1 & 0 & 0 & 0 & 0 \\ 0 & 0 & 0 & 1 & 0 & 0 \\ 1 & 0 & 0 & 0 & 0 & 0 \\ 0 & 0 & 1 & 0 & 0 & 0 \\ 0 & 0 & 0 & - 1 & 0 & 0 \\ 0 & 0 & 0 & 0 & 0 & 1\end{matrix} ]$$

From another point of view, W⁶′ can be constructed from W⁶ according to sequence correspondence relation between antenna ports numberings. In particular, row 0 of W⁶′ is row 0 of W⁶; row 1 of W⁶′ is row 1 of W⁶; row 2 of W⁶′ is row 4 of W⁶; row 3 of W⁶′ is row 5 of W⁶; row 4 of W⁶′ is row 2 of W⁶; row 5 of W⁶′ is row 3 of W⁶; row 6 of W⁶′ is row 6 of W 6; and row 7 of W⁶′ is row 7 of W 6.

Similarly, when row 1 and row 4 of W⁶ are swapped and row 3 and row 6 of W 6 are swapped, the rank 6 precoding matrix for the third antenna ports numbering shown in FIGS. 4(a) and 4(b) can be constructed as

$${W}^{6 ″} = \frac{1}{2 \sqrt{2}} [ \begin{matrix}1 & 0 & 0 & 0 & 0 & 0 \\ 0 & 0 & 0 & 1 & 0 & 0 \\ 1 & 0 & 0 & 0 & 0 & 0 \\ 0 & 0 & 0 & - 1 & 0 & 0 \\ 0 & 1 & 0 & 0 & 0 & 0 \\ 0 & 0 & 0 & 0 & 1 & 0 \\ 0 & 0 & 1 & 0 & 0 & 0 \\ 0 & 0 & 0 & 0 & 0 & 1\end{matrix} ] .$$

From another point of view, W⁶″ can be constructed from W⁶ according to sequence correspondence relation between antenna ports numberings. In particular, row 0 of W⁶″ is row 0 of W⁶; row 1 of W⁶″ is row 4 of W⁶; row 2 of W⁶″ is row 2 of W⁶; row 3 of W⁶″ is row 6 of W⁶; row 4 of W⁶″ is row 1 of W⁶; row 5 of W⁶″ is row 5 of W⁶; row 6 of W⁶″ is row 3 of W⁶; and row 7 of W⁶″ is row 7 of W⁶.

Similarly, the rank 6 precoding matrix for the fourth antenna ports numbering shown in FIGS. 5(a) and 5(b) W⁶′″ can be constructed from W⁶ as follows: row 0 of W⁶′″ is row 0 of W⁶; row 1 of W⁶′″ is row 4 of W⁶; row 2 of W⁶′″ is row 1 of W⁶; row 3 of W⁶′″ is row 5 of W⁶; row 4 of W⁶′″ is row 2 of W⁶; row 5 of W⁶′″ is row 6 of W⁶; row 6 of W⁶′″ is row 3 of W⁶; and row 7 of W⁶′″ is row 7 of W⁶. Accordingly,

$${W}^{6 ′′′} = \frac{1}{2 \sqrt{2}} [ \begin{matrix}1 & 0 & 0 & 0 & 0 & 0 \\ 0 & 0 & 0 & 1 & 0 & 0 \\ 0 & 1 & 0 & 0 & 0 & 0 \\ 0 & 0 & 0 & 0 & 1 & 0 \\ 1 & 0 & 0 & 0 & 0 & 0 \\ 0 & 0 & 0 & - 1 & 0 & 0 \\ 0 & 0 & 1 & 0 & 0 & 0 \\ 0 & 0 & 0 & 0 & 0 & 1\end{matrix} ]$$

As a whole, by rearranging the rows of the 8TX rank N (N is from 1 to 8) precoding matrix obtained by taking the first antenna ports numbering into consideration according to sequence correspondence between any antenna ports numbers and the first antenna ports numbers, the 8TX rank N (N is from 1 to 8) precoding matrix by taking any antenna ports numbering into consideration can be constructed from the 8TX rank N (N is from 1 to 8) precoding matrix determined according to first to eighth sub-embodiments of the second embodiment.

According to a third embodiment, the joint TPMI indication or the separate TPMI indication described in the first embodiment or the second embodiment can be implemented in the TPMI that is included in the TPMI field. The TPMI field can be used in DCI format 0_1 or 0_2 to schedule dynamically scheduled PUSCH or type 2 configured-grant PUSCH, or in RRC message (configuredGrantConfig) to configure type 1 configured-grant PUSCH.

FIG. 6 is a schematic flow chart diagram illustrating an embodiment of a method 600 according to the present application. In some embodiments, the method 600 is performed by an apparatus, such as a remote unit (e.g., UE). In certain embodiments, the method 600 may be performed by a processor executing program code, for example, a microcontroller, a microprocessor, a CPU, a GPU, an auxiliary processing unit, a FPGA, or the like.

The method 600 is a method performed at a UE, comprising: 602 receiving a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and 604 transmitting the scheduled PUSCH transmission according to the control message.

In some embodiment, the four coherent antenna groups are divided into two antenna group pairs each of which consists of two coherent antenna groups, and the TMPI indicates one or two 4TX partial coherent precoding matrices each of which is used by one of the two antenna group pairs.

In some embodiment, each 4TX partial coherent precoding matrix is split into two 2TX precoding matrices, each of which is used as the precoding matrix of one of the two coherent antenna groups of the antenna group pair using the 4TX partial coherent precoding matrix. If the transmission rank is 1, the one 4TX partial coherent precoding matrix is 4TX rank 1 precoding matrix and is used by one antenna group pair indicated by the TPMI. If the transmission rank is 2, both 4TX partial coherent precoding matrices are 4TX rank 1 precoding matrices. If the transmission rank is 3, one of the two 4TX partial coherent precoding matrices is 4TX rank 1 precoding matrix and the other of the two 4TX partial coherent precoding matrices is 4TX rank 2 precoding matrix. If the transmission rank is 4, both 4TX partial coherent precoding matrices are 4TX rank 2 precoding matrices. If the transmission rank is 5, one of the two 4TX partial coherent precoding matrices is 4TX rank 2 precoding matrix and the other of the two 4TX partial coherent precoding matrices is 4TX rank 3 precoding matrix. If the transmission rank is 6, both 4TX partial coherent precoding matrices are 4TX rank 3 precoding matrices. If the transmission rank is 7, one of the two 4TX partial coherent precoding matrices is 4TX rank 3 precoding matrix and the other of the two 4TX partial coherent precoding matrices is 4TX rank 4 precoding matrix. If the transmission rank is 8, and both 4TX partial coherent precoding matrices are 4TX rank 4 precoding matrices.

In some embodiment, each 4TX partial coherent precoding matrix is chosen from all 4TX partial coherent precoding matrices of a proper rank.

In some embodiment, at least one of the two partial coherent precoding matrices is chosen from only a part of 4TX partial coherent precoding matrices of a proper rank. In particular, the 2TX precoding matrix of each coherent antenna group is different from the 2TX precoding matrix of any other coherent antenna group.

In some embodiment, the TPMI includes a single indication of the one 4TX partial coherent precoding matrix or a combination of the two 4TX partial coherent precoding matrices.

Alternatively, the TPMI includes a first part indicating one of the two 4TX partial coherent precoding matrix and a second part indicating the other of the two 4TX partial coherent precoding matrix. In particular, the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

In some embodiment, each of the split two 2TX precoding matrices is applied to one coherent antenna group including two antenna ports depending on antenna ports numbering.

In some embodiment, the TPMI indicates a combination of coherent antenna groups and 2TX rank 1 full coherent precoding matrices. If the transmission rank is 1, the TMPI indicates one of the four coherent antenna groups and one 2TX rank 1 full coherent precoding matrix. If the transmission rank is 2, the TMPI indicates a combination of two of the four coherent antenna groups and a combination of two 2TX rank 1 full coherent precoding matrices.

If the transmission rank is 3, the TMPI indicates a combination of three of the four coherent antenna groups and a combination of three 2TX rank 1 full coherent precoding matrices. If the transmission rank is 4, the 8TX rank 4 precoding matrix is consisted of four 2TX rank 1 full coherent precoding matrices, wherein, the four 2TX rank 1 full coherent precoding matrices are applied to the four coherent antenna groups in a sequential manner. If the transmission rank is 5, the TPMI indicates one of a third coherent antenna group and a fourth coherent antenna group to which one 2TX rank 1 full coherent precoding matrix is added and which one of the four 2TX rank 1 full coherent precoding matrices is the added one 2TX rank 1 full coherent precoding matrix. If the transmission rank is 6, the TPMI indicates one of a first coherent antenna group and a second coherent antenna group to which a first 2TX rank 1 full coherent precoding matrix is added and one of a third coherent antenna group and a fourth coherent antenna group to which a second 2TX rank 1 full coherent precoding matrix is added, and which one of the four 2TX rank 1 full coherent precoding matrices is the added first 2TX rank 1 full coherent precoding matrix and which one of the four 2TX rank 1 full coherent precoding matrices is the added second 2TX rank 1 full coherent precoding matrix. If the transmission rank is 7, the TPMI indicates one of a first coherent antenna group and a second coherent antenna group to which a first 2TX rank 1 full coherent precoding matrix is added, and which one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and which one of the four 2TX rank 1 full coherent precoding matrices is an added third 2TX rank 1 full coherent precoding matrix to a fourth coherent antenna group. If the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group. In particular, each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and if there are two or three or four added 2TX rank 1 full coherent precoding matrices, each of the two or three or four added 2TX rank 1 full coherent precoding matrices is different.

In some embodiment, if the transmission rank is r that is larger than 4, the TPMI indicates r-4 2TX rank 1 full coherent precoding matrix(ces), each of which is added to one of r-4 antenna groups based on 8TX rank 4 precoding matrix. If r is 5, one 2TX rank 1 full coherent precoding matrix is added to a third antenna group or a fourth antenna group. If r is 7, one 2TX rank 1 full coherent precoding matrix is added to a first antenna group or a second antenna group, and two 2TX rank 1 full coherent precoding matrices are added to the third antenna group and the fourth antenna group. Each of the antenna group(s) to which one 2TX rank 1 full coherent precoding matrix is added transmits two data layers.

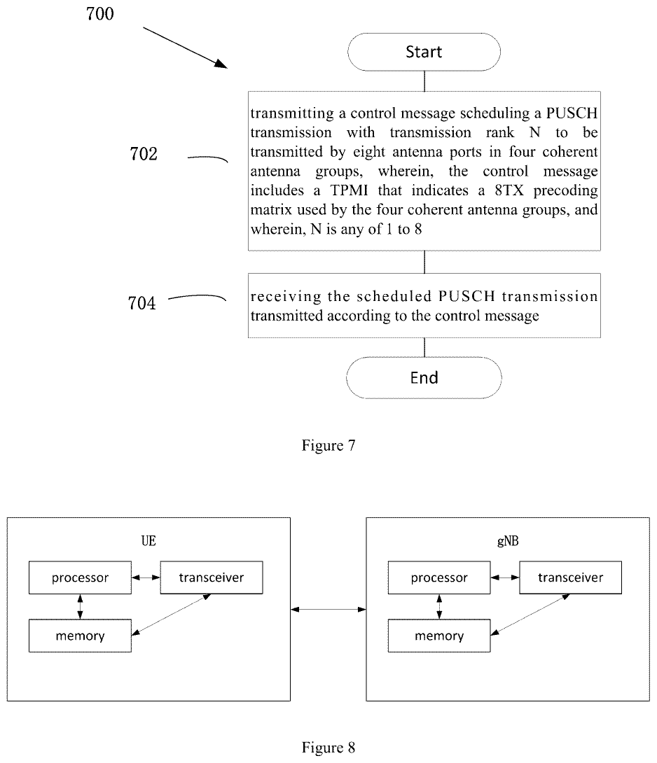

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like.

The method 700 may comprise 702 transmitting a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and 704 receiving the scheduled PUSCH transmission transmitted according to the control message.

In some embodiment, the four coherent antenna groups are divided into two antenna group pairs each of which consists of two coherent antenna groups, and the TMPI indicates one or two 4TX partial coherent precoding matrices each of which is used by one of the two antenna group pairs.

In some embodiment, each 4TX partial coherent precoding matrix is split into two 2TX precoding matrices, each of which is used as the precoding matrix of one of the two coherent antenna groups of the antenna group pair using the 4TX partial coherent precoding matrix. If the transmission rank is 1, the one 4TX partial coherent precoding matrix is 4TX rank 1 precoding matrix and is used by one antenna group pair indicated by the TPMI. If the transmission rank is 2, both 4TX partial coherent precoding matrices are 4TX rank 1 precoding matrices. If the transmission rank is 3, one of the two 4TX partial coherent precoding matrices is 4TX rank 1 precoding matrix and the other of the two 4TX partial coherent precoding matrices is 4TX rank 2 precoding matrix. If the transmission rank is 4, both 4TX partial coherent precoding matrices are 4TX rank 2 precoding matrices. If the transmission rank is 5, one of the two 4TX partial coherent precoding matrices is 4TX rank 2 precoding matrix and the other of the two 4TX partial coherent precoding matrices is 4TX rank 3 precoding matrix. If the transmission rank is 6, both 4TX partial coherent precoding matrices are 4TX rank 3 precoding matrices. If the transmission rank is 7, one of the two 4TX partial coherent precoding matrices is 4TX rank 3 precoding matrix and the other of the two 4TX partial coherent precoding matrices is 4TX rank 4 precoding matrix. If the transmission rank is 8, and both 4TX partial coherent precoding matrices are 4TX rank 4 precoding matrices.

In some embodiment, each 4TX partial coherent precoding matrix is chosen from all 4TX partial coherent precoding matrices of a proper rank.

In some embodiment, at least one of the two partial coherent precoding matrices is chosen from only a part of 4TX partial coherent precoding matrices of a proper rank. In particular, the 2TX precoding matrix of each coherent antenna group is different from the 2TX precoding matrix of any other coherent antenna group.

In some embodiment, the TPMI includes a single indication of the one 4TX partial coherent precoding matrix or a combination of the two 4TX partial coherent precoding matrices.

Alternatively, the TPMI includes a first part indicating one of the two 4TX partial coherent precoding matrix and a second part indicating the other of the two 4TX partial coherent precoding matrix. In particular, the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

In some embodiment, each of the split two 2TX precoding matrices is applied to one coherent antenna group including two antenna ports depending on antenna ports numbering.

In some embodiment, the TPMI indicates a combination of coherent antenna groups and 2TX rank 1 full coherent precoding matrices. If the transmission rank is 1, the TMPI indicates one of the four coherent antenna groups and one 2TX rank 1 full coherent precoding matrix. If the transmission rank is 2, the TMPI indicates a combination of two of the four coherent antenna groups and a combination of two 2TX rank 1 full coherent precoding matrices. If the transmission rank is 3, the TMPI indicates a combination of three of the four coherent antenna groups and a combination of three 2TX rank 1 full coherent precoding matrices. If the transmission rank is 4, the 8TX rank 4 precoding matrix is consisted of four 2TX rank 1 full coherent precoding matrices, wherein, the four 2TX rank 1 full coherent precoding matrices are applied to the four coherent antenna groups in a sequential manner. If the transmission rank is 5, the TPMI indicates one of a third coherent antenna group and a fourth coherent antenna group to which one 2TX rank 1 full coherent precoding matrix is added and which one of the four 2TX rank 1 full coherent precoding matrices is the added one 2TX rank 1 full coherent precoding matrix. If the transmission rank is 6, the TPMI indicates one of a first coherent antenna group and a second coherent antenna group to which a first 2TX rank 1 full coherent precoding matrix is added and one of a third coherent antenna group and a fourth coherent antenna group to which a second 2TX rank 1 full coherent precoding matrix is added, and which one of the four 2TX rank 1 full coherent precoding matrices is the added first 2TX rank 1 full coherent precoding matrix and which one of the four 2TX rank 1 full coherent precoding matrices is the added second 2TX rank 1 full coherent precoding matrix. If the transmission rank is 7, the TPMI indicates one of a first coherent antenna group and a second coherent antenna group to which a first 2TX rank 1 full coherent precoding matrix is added, and which one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and which one of the four 2TX rank 1 full coherent precoding matrices is an added third 2TX rank 1 full coherent precoding matrix to a fourth coherent antenna group. If the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group. In particular, each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and if there are two or three or four added 2TX rank 1 full coherent precoding matrices, each of the two or three or four added 2TX rank 1 full coherent precoding matrices is different.

In some embodiment, if the transmission rank is r that is larger than 4, the TPMI indicates r-4 2TX rank 1 full coherent precoding matrix(ces), each of which is added to one of r-4 antenna groups based on 8TX rank 4 precoding matrix. If r is 5, one 2TX rank 1 full coherent precoding matrix is added to a third antenna group or a fourth antenna group. If r is 7, one 2TX rank 1 full coherent precoding matrix is added to a first antenna group or a second antenna group, and two 2TX rank 1 full coherent precoding matrices are added to the third antenna group and the fourth antenna group. Each of the antenna group(s) to which one 2TX rank 1 full coherent precoding matrix is added transmits two data layers.

FIG. 8 is a schematic block diagram illustrating apparatuses according to one embodiment.

Referring to FIG. 8, the UE (i.e., the remote unit) includes a processor, a memory, and a transceiver. The processor implements a function, a process, and/or a method which are proposed in FIG. 6.

A UE comprises a transceiver; and a processor coupled to the transceiver, wherein the processor is configured to receive, via the transceiver, a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and transmit, via the transceiver, the scheduled PUSCH transmission according to the control message.

In some embodiment, the four coherent antenna groups are divided into two antenna group pairs each of which consists of two coherent antenna groups, and the TMPI indicates one or two 4TX partial coherent precoding matrices each of which is used by one of the two antenna group pairs.

In some embodiment, each 4TX partial coherent precoding matrix is split into two 2TX precoding matrices, each of which is used as the precoding matrix of one of the two coherent antenna groups of the antenna group pair using the 4TX partial coherent precoding matrix. If the transmission rank is 1, the one 4TX partial coherent precoding matrix is 4TX rank 1 precoding matrix and is used by one antenna group pair indicated by the TPMI. If the transmission rank is 2, both 4TX partial coherent precoding matrices are 4TX rank 1 precoding matrices. If the transmission rank is 3, one of the two 4TX partial coherent precoding matrices is 4TX rank 1 precoding matrix and the other of the two 4TX partial coherent precoding matrices is 4TX rank 2 precoding matrix. If the transmission rank is 4, both 4TX partial coherent precoding matrices are 4TX rank 2 precoding matrices. If the transmission rank is 5, one of the two 4TX partial coherent precoding matrices is 4TX rank 2 precoding matrix and the other of the two 4TX partial coherent precoding matrices is 4TX rank 3 precoding matrix. If the transmission rank is 6, both 4TX partial coherent precoding matrices are 4TX rank 3 precoding matrices. If the transmission rank is 7, one of the two 4TX partial coherent precoding matrices is 4TX rank 3 precoding matrix and the other of the two 4TX partial coherent precoding matrices is 4TX rank 4 precoding matrix. If the transmission rank is 8, and both 4TX partial coherent precoding matrices are 4TX rank 4 precoding matrices.

In some embodiment, each 4TX partial coherent precoding matrix is chosen from all 4TX partial coherent precoding matrices of a proper rank.

In some embodiment, at least one of the two partial coherent precoding matrices is chosen from only a part of 4TX partial coherent precoding matrices of a proper rank. In particular, the 2TX precoding matrix of each coherent antenna group is different from the 2TX precoding matrix of any other coherent antenna group.

In some embodiment, the TPMI includes a single indication of the one 4TX partial coherent precoding matrix or a combination of the two 4TX partial coherent precoding matrices.

Alternatively, the TPMI includes a first part indicating one of the two 4TX partial coherent precoding matrix and a second part indicating the other of the two 4TX partial coherent precoding matrix. In particular, the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

In some embodiment, each of the split two 2TX precoding matrices is applied to one coherent antenna group including two antenna ports depending on antenna ports numbering.

In some embodiment, the TPMI indicates a combination of coherent antenna groups and 2TX rank 1 full coherent precoding matrices. If the transmission rank is 1, the TMPI indicates one of the four coherent antenna groups and one 2TX rank 1 full coherent precoding matrix. If the transmission rank is 2, the TMPI indicates a combination of two of the four coherent antenna groups and a combination of two 2TX rank 1 full coherent precoding matrices. If the transmission rank is 3, the TMPI indicates a combination of three of the four coherent antenna groups and a combination of three 2TX rank 1 full coherent precoding matrices. If the transmission rank is 4, the 8TX rank 4 precoding matrix is consisted of four 2TX rank 1 full coherent precoding matrices, wherein, the four 2TX rank 1 full coherent precoding matrices are applied to the four coherent antenna groups in a sequential manner. If the transmission rank is 5, the TPMI indicates one of a third coherent antenna group and a fourth coherent antenna group to which one 2TX rank 1 full coherent precoding matrix is added and which one of the four 2TX rank 1 full coherent precoding matrices is the added one 2TX rank 1 full coherent precoding matrix. If the transmission rank is 6, the TPMI indicates one of a first coherent antenna group and a second coherent antenna group to which a first 2TX rank 1 full coherent precoding matrix is added and one of a third coherent antenna group and a fourth coherent antenna group to which a second 2TX rank 1 full coherent precoding matrix is added, and which one of the four 2TX rank 1 full coherent precoding matrices is the added first 2TX rank 1 full coherent precoding matrix and which one of the four 2TX rank 1 full coherent precoding matrices is the added second 2TX rank 1 full coherent precoding matrix. If the transmission rank is 7, the TPMI indicates one of a first coherent antenna group and a second coherent antenna group to which a first 2TX rank 1 full coherent precoding matrix is added, and which one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and which one of the four 2TX rank 1 full coherent precoding matrices is an added third 2TX rank 1 full coherent precoding matrix to a fourth coherent antenna group. If the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group. In particular, each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and if there are two or three or four added 2TX rank 1 full coherent precoding matrices, each of the two or three or four added 2TX rank 1 full coherent precoding matrices is different.

In some embodiment, if the transmission rank is r that is larger than 4, the TPMI indicates r-4 2TX rank 1 full coherent precoding matrix(ces), each of which is added to one of r-4 antenna groups based on 8TX rank 4 precoding matrix. If r is 5, one 2TX rank 1 full coherent precoding matrix is added to a third antenna group or a fourth antenna group. If r is 7, one 2TX rank 1 full coherent precoding matrix is added to a first antenna group or a second antenna group, and two 2TX rank 1 full coherent precoding matrices are added to the third antenna group and the fourth antenna group. Each of the antenna group(s) to which one 2TX rank 1 full coherent precoding matrix is added transmits two data layers.

The gNB (i.e., the base unit) includes a processor, a memory, and a transceiver. The processor implements a function, a process, and/or a method which are proposed in FIG. 7.

A base unit comprises a transceiver; and a processor coupled to the transceiver, wherein the processor is configured to transmit, via the transceiver, a control message scheduling a PUSCH transmission with transmission rank N to be transmitted by eight antenna ports in four coherent antenna groups, wherein, the control message includes a TPMI that indicates a 8TX precoding matrix used by the four coherent antenna groups, and wherein, N is any of 1 to 8; and receive, via the transceiver, the scheduled PUSCH transmission transmitted according to the control message

In some embodiment, the four coherent antenna groups are divided into two antenna group pairs each of which consists of two coherent antenna groups, and the TMPI indicates one or two 4TX partial coherent precoding matrices each of which is used by one of the two antenna group pairs.

In some embodiment, each 4TX partial coherent precoding matrix is split into two 2TX precoding matrices, each of which is used as the precoding matrix of one of the two coherent antenna groups of the antenna group pair using the 4TX partial coherent precoding matrix. If the transmission rank is 1, the one 4TX partial coherent precoding matrix is 4TX rank 1 precoding matrix and is used by one antenna group pair indicated by the TPMI. If the transmission rank is 2, both 4TX partial coherent precoding matrices are 4TX rank 1 precoding matrices. If the transmission rank is 3, one of the two 4TX partial coherent precoding matrices is 4TX rank 1 precoding matrix and the other of the two 4TX partial coherent precoding matrices is 4TX rank 2 precoding matrix. If the transmission rank is 4, both 4TX partial coherent precoding matrices are 4TX rank 2 precoding matrices. If the transmission rank is 5, one of the two 4TX partial coherent precoding matrices is 4TX rank 2 precoding matrix and the other of the two 4TX partial coherent precoding matrices is 4TX rank 3 precoding matrix. If the transmission rank is 6, both 4TX partial coherent precoding matrices are 4TX rank 3 precoding matrices. If the transmission rank is 7, one of the two 4TX partial coherent precoding matrices is 4TX rank 3 precoding matrix and the other of the two 4TX partial coherent precoding matrices is 4TX rank 4 precoding matrix. If the transmission rank is 8, and both 4TX partial coherent precoding matrices are 4TX rank 4 precoding matrices.

In some embodiment, each 4TX partial coherent precoding matrix is chosen from all 4TX partial coherent precoding matrices of a proper rank.

In some embodiment, at least one of the two partial coherent precoding matrices is chosen from only a part of 4TX partial coherent precoding matrices of a proper rank. In particular, the 2TX precoding matrix of each coherent antenna group is different from the 2TX precoding matrix of any other coherent antenna group.

In some embodiment, the TPMI includes a single indication of the one 4TX partial coherent precoding matrix or a combination of the two 4TX partial coherent precoding matrices.

Alternatively, the TPMI includes a first part indicating one of the two 4TX partial coherent precoding matrix and a second part indicating the other of the two 4TX partial coherent precoding matrix. In particular, the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

In some embodiment, each of the split two 2TX precoding matrices is applied to one coherent antenna group including two antenna ports depending on antenna ports numbering.

In some embodiment, the TPMI indicates a combination of coherent antenna groups and 2TX rank 1 full coherent precoding matrices. If the transmission rank is 1, the TMPI indicates one of the four coherent antenna groups and one 2TX rank 1 full coherent precoding matrix. If the transmission rank is 2, the TMPI indicates a combination of two of the four coherent antenna groups and a combination of two 2TX rank 1 full coherent precoding matrices. If the transmission rank is 3, the TMPI indicates a combination of three of the four coherent antenna groups and a combination of three 2TX rank 1 full coherent precoding matrices. If the transmission rank is 4, the 8TX rank 4 precoding matrix is consisted of four 2TX rank 1 full coherent precoding matrices, wherein, the four 2TX rank 1 full coherent precoding matrices are applied to the four coherent antenna groups in a sequential manner. If the transmission rank is 5, the TPMI indicates one of a third coherent antenna group and a fourth coherent antenna group to which one 2TX rank 1 full coherent precoding matrix is added and which one of the four 2TX rank 1 full coherent precoding matrices is the added one 2TX rank 1 full coherent precoding matrix. If the transmission rank is 6, the TPMI indicates one of a first coherent antenna group and a second coherent antenna group to which a first 2TX rank 1 full coherent precoding matrix is added and one of a third coherent antenna group and a fourth coherent antenna group to which a second 2TX rank 1 full coherent precoding matrix is added, and which one of the four 2TX rank 1 full coherent precoding matrices is the added first 2TX rank 1 full coherent precoding matrix and which one of the four 2TX rank 1 full coherent precoding matrices is the added second 2TX rank 1 full coherent precoding matrix. If the transmission rank is 7, the TPMI indicates one of a first coherent antenna group and a second coherent antenna group to which a first 2TX rank 1 full coherent precoding matrix is added, and which one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and which one of the four 2TX rank 1 full coherent precoding matrices is an added third 2TX rank 1 full coherent precoding matrix to a fourth coherent antenna group. If the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group. In particular, each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and if there are two or three or four added 2TX rank 1 full coherent precoding matrices, each of the two or three or four added 2TX rank 1 full coherent precoding matrices is different.

In some embodiment, if the transmission rank is r that is larger than 4, the TPMI indicates r-4 2TX rank 1 full coherent precoding matrix(ces), each of which is added to one of r-4 antenna groups based on 8TX rank 4 precoding matrix. If r is 5, one 2TX rank 1 full coherent precoding matrix is added to a third antenna group or a fourth antenna group. If r is 7, one 2TX rank 1 full coherent precoding matrix is added to a first antenna group or a second antenna group, and two 2TX rank 1 full coherent precoding matrices are added to the third antenna group and the fourth antenna group. Each of the antenna group(s) to which one 2TX rank 1 full coherent precoding matrix is added transmits two data layers.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a control message scheduling a physical uplink shared channel (PUSCH)transmission with transmission rank N to be transmitted by eight antenna ports in four coherent antenna groups, wherein the control message includes a transmit precoding matrix indicator (TPMI) that indicates a 8TX precoding matrix used by the four coherent antenna groups, and wherein the transmission rank N is one of 1 to 8; and
transmit the scheduled PUSCH transmission according to the control message.

2. The UE of claim 1, wherein:
the four coherent antenna groups are divided into two antenna group pairs that each include two coherent antenna groups; and
the TMPI indicates one or two 4TX partial coherent precoding matrices each of which is used by one of the two antenna group pairs.

3. The UE of claim 2, wherein each 4TX partial coherent precoding matrix is split into two 2TX precoding matrices, each of which is used as the precoding matrix of one of the two coherent antenna groups of the antenna group pair using the 4TX partial coherent precoding matrix.

4. The UE of claim 3, wherein one of:
if the transmission rank is 1, the one 4TX partial coherent precoding matrix is 4TX rank 1 precoding matrix and is used by one antenna group pair indicated by the TPMI;
if the transmission rank is 2, both 4TX partial coherent precoding matrices are 4TX rank 1 precoding matrices;
if the transmission rank is 3, one of the two 4TX partial coherent precoding matrices is 4TX rank 1 precoding matrix and the other of the two 4TX partial coherent precoding matrices is 4TX rank 2 precoding matrix;
if the transmission rank is 4, both 4TX partial coherent precoding matrices are 4TX rank 2 precoding matrices;
if the transmission rank is 5, one of the two 4TX partial coherent precoding matrices is 4TX rank 2 precoding matrix and the other of the two 4TX partial coherent precoding matrices is 4TX rank 3 precoding matrix;
if the transmission rank is 6, both 4TX partial coherent precoding matrices are 4TX rank 3 precoding matrices;
if the transmission rank is 7, one of the two 4TX partial coherent precoding matrices is 4TX rank 3 precoding matrix and the other of the two 4TX partial coherent precoding matrices is 4TX rank 4 precoding matrix; or
if the transmission rank is 8, both of the 4TX partial coherent precoding matrices are 4TX rank 4 precoding matrices.

5. The UE of claim 2, wherein each 4TX partial coherent precoding matrix is chosen from all 4TX partial coherent precoding matrices of a proper rank.

6. The UE of claim 2, wherein at least one of the two partial coherent precoding matrices is chosen from only a part of 4TX partial coherent precoding matrices of a proper rank.

7. The UE of claim 6, wherein a 2TX precoding matrix of each coherent antenna group is different from the 2TX precoding matrix of any other coherent antenna group.

8. The UE of claim 2, wherein the TPMI includes a single indication of the one 4TX partial coherent precoding matrix or a combination of the two 4TX partial coherent precoding matrices.

9. The UE of claim 2, wherein the TPMI includes a first part indicating one of the two 4TX partial coherent precoding matrix and a second part indicating the other of the two 4TX partial coherent precoding matrix.

10. The UE of claim 9, wherein the second part indicates the other of the two 4TX partial coherent precoding matrices from a subset of precoding matrices of a proper rank based on the indication of the one of the two 4TX partial coherent precoding matrix by the first part, or the first part indicates the one of the two 4TX partial coherent precoding matrices from a subset of precoding matrices of a proper rank based on the indication of the other of the two 4TX partial coherent precoding matrix by the second part.

11. The UE of claim 3, wherein each of the split two 2TX precoding matrices is applied to one coherent antenna group including two antenna ports depending on antenna ports numbering.

12. The UE of claim 1, wherein the TPMI indicates a combination of coherent antenna groups and 2TX rank 1 full coherent precoding matrices.

13. The UE of claim 12, wherein one of:
if the transmission rank is 1, the TMPI indicates one of the four coherent antenna groups and one 2TX rank 1 full coherent precoding matrix;
if the transmission rank is 2, the TMPI indicates a combination of two of the four coherent antenna groups and a combination of two 2TX rank 1 full coherent precoding matrices;
if the transmission rank is 3, the TMPI indicates a combination of three of the four coherent antenna groups and a combination of three 2TX rank 1 full coherent precoding matrices;
if the transmission rank is 4, the 8TX rank 4 precoding matrix includes four 2TX rank 1 full coherent precoding matrices, wherein the four 2TX rank 1 full coherent precoding matrices are applied to the four coherent antenna groups in a sequential manner;
if the transmission rank is 5, the TPMI indicates one of a third coherent antenna group and a fourth coherent antenna group to which one 2TX rank 1 full coherent precoding matrix is added and one of the four 2TX rank 1 full coherent precoding matrices is the added one 2TX rank 1 full coherent precoding matrix;
if the transmission rank is 6, the TPMI indicates one of a first coherent antenna group or a second coherent antenna group to which a first 2TX rank 1 full coherent precoding matrix is added and one of a third coherent antenna group and a fourth coherent antenna group to which a second 2TX rank 1 full coherent precoding matrix is added, and one of the four 2TX rank 1 full coherent precoding matrices is the added first 2TX rank 1 full coherent precoding matrix and one of the four 2TX rank 1 full coherent precoding matrices is the added second 2TX rank 1 full coherent precoding matrix;
if the transmission rank is 7, the TPMI indicates one of a first coherent antenna group or a second coherent antenna group to which a first 2TX rank 1 full coherent precoding matrix is added, and one of the four 2TX rank 1 full coherent precoding matrices is the added first 2TX rank 1 full coherent precoding matrix, which one of the four 2TX rank 1 full coherent precoding matrices is an added second 2TX rank 1 full coherent precoding matrix to a third coherent antenna group, and one of the four 2TX rank 1 full coherent precoding matrices is an added third 2TX rank 1 full coherent precoding matrix to a fourth coherent antenna group; or
if the transmission rank is 8, the TPMI indicates which one of the four 2TX rank 1 full coherent precoding matrices is an added first 2TX rank 1 full coherent precoding matrix to a first coherent antenna group, which one of the four 2TX rank 1 full coherent precoding matrices is an added second 2TX rank 1 full coherent precoding matrix to a second coherent antenna group, which one of the four 2TX rank 1 full coherent precoding matrices is an added third 2TX rank 1 full coherent precoding matrix to a third coherent antenna group, and which one of the four 2TX rank 1 full coherent precoding matrices is an added fourth 2TX rank 1 full coherent precoding matrix to a fourth coherent antenna group.

14. The UE of claim 13, wherein:
each added 2TX rank 1 full coherent precoding matrix is different from the 2TX rank 1 full coherent precoding matrix originally applied to the coherent antenna group to which the added 2TX rank 1 full coherent precoding matrix is added in the 8TX rank 4 precoding matrix, and
if there are two or three or four added 2TX rank 1 full coherent precoding matrices, each of the two or three or four added 2TX rank 1 full coherent precoding matrices is different.

15. The UE of claim 12, wherein if the transmission rank is r that is larger than 4, the TPMI indicates one or more r-4 2TX rank 1 full coherent precoding matrices, each of which is added to one of r-4 antenna groups based on 8TX rank 4 precoding matrix.

16. The UE of claim 15, wherein:
if r is 5, one 2TX rank 1 full coherent precoding matrix is added to a third antenna group or a fourth antenna group; and
if r is 7, one 2TX rank 1 full coherent precoding matrix is added to a first antenna group or a second antenna group, and two 2TX rank 1 full coherent precoding matrices are added to the third antenna group and the fourth antenna group.

17. The UE of claim 15, wherein each of the one or more antenna groups to which one 2TX rank 1 full coherent precoding matrix is added transmits two data layers.

18. A method performed by a user equipment (UE), the method comprising:
receiving a control message scheduling a physical uplink shared channel (PUSCH) transmission with transmission rank N to be transmitted by eight antenna ports in four coherent antenna groups, wherein the control message includes a transmit precoding matrix indicator (TPMI) that indicates a 8TX precoding matrix used by the four coherent antenna groups, and wherein the transmission rank N is one of 1 to 8; and
transmitting the scheduled PUSCH transmission according to the control message.

19. A base unit for wireless communication, comprising:
at least one memory; and
at least one processor coupled with the at least one memory and configured to cause the base unit to:
transmit a control message scheduling a physical uplink shared channel (PUSCH) transmission with transmission rank N to be transmitted by eight antenna ports in four coherent antenna groups, wherein the control message includes a transmit precoding matrix indicator (TPMI) that indicates a 8TX precoding matrix used by the four coherent antenna groups, and wherein the transmission rank N is one of 1 to 8; and
receive the scheduled PUSCH transmission transmitted according to the control message.

20-35. (canceled)

36. A method performed by a base unit, the method comprising:
transmitting a control message scheduling a physical uplink shared channel (PUSCH) transmission with transmission rank N to be transmitted by eight antenna ports in four coherent antenna groups, wherein the control message includes a transmit precoding matrix indicator (TPMI) that indicates a 8TX precoding matrix used by the four coherent antenna groups, and wherein the transmission rank N is one of 1 to 8; and
receiving the scheduled PUSCH transmission transmitted according to the control message.
